(19) United States
(12) Patent Application Publication
(10) Pub. No.: US 2022/0138568 A1
(43) Pub. Date: May 5, 2022

(54) MODEL-BASED REINFORCEMENT LEARNING FOR BEHAVIOR PREDICTION

(71) Applicant: NVIDIA Corporation, Santa Clara, CA (US)

(72) Inventors: Nikolai Smolyanskiy, Seattle, WA (US); Alexey Kamenev, Carlsbad, CA (US); Lirui Wang, Cambridge, MA (US); David Nister, Bellevue, WA (US); Ollin Boer Bohan, Redmond, WA (US); Ishwar Kulkarni, San Jose, CA (US); Fangkai Yang, Seattle, WA (US); Julia Ng, San Jose, CA (US); Alperen Degirmenci, Jersey City, NJ (US); Ruchi Bhargava, Redmond, WA (US); Rotem Aviv, San Diego, CA (US)

(21) Appl. No.: 17/453,055

(22) Filed: Nov. 1, 2021

Related U.S. Application Data
(60) Provisional application No. 63/108,432, filed on Nov. 1, 2020.

(51) Int. Cl. G06N 3/08; G06N 3/04

(52) U.S. Cl. CPC G06N 3/08; G06N 3/0427

(57) ABSTRACT

In various examples, reinforcement learning is used to train at least one machine learning model (MLM) to control a vehicle by leveraging a deep neural network (DNN) trained on real-world data by using imitation learning to predict movements of one or more actors to define a world model. The DNN may be trained from real-world data to predict attributes of actors, such as locations and/or movements, from input attributes. The predictions may define states of the environment in a simulator, and one or more attributes of one or more actors input into the DNN may be modified or controlled by the simulator to simulate conditions that may otherwise be unfeasible. The MLM(s) may leverage predictions made by the DNN to predict one or more actions for the vehicle.

### CROSS-REFERENCE TO RELATED APPLICATIONS

This application claims the benefit of U.S. Provisional Application No. 63/108,432, filed on Nov. 1, 2020 and titled “Model-Based Reinforcement Learning for Behavior Planning in Autonomous Machines”, which is hereby incorporated by reference in its entirety.

### BACKGROUND

Machine learning techniques such as reinforcement learning (RL) that employ trial-and-error methods may be used to train optimal policies for planning and control operations in robotics applications. However, using reinforcement learning to train driving policies for autonomous and semi-autonomous vehicles can be challenging. For example, in robotics, policies can be trained in a simulator or in a very limited way on real robotic systems. However, transferring simulator-trained policies to vehicles is difficult due to domain differences and modelling differences. For example, according to conventional approaches, to achieve accurate results a simulator used to train driving policies using reinforcement learning may need to simulate all of the driving conditions, which would be unfeasible. Additionally, applying reinforcement learning techniques directly to real robotics systems can violate safety requirements, as they may require placing a driver, machine operator, the autonomous system itself, or objects or actors within the local environment in dangerous situations. These issues have contributed to limiting the wider adoption of reinforcement learning algorithms for planning and control in autonomous vehicles.

### SUMMARY

Embodiments of the present disclosure relate to model-based reinforcement learning for behavior prediction. Systems and methods are disclosed that may be used to train models using Reinforcement Learning (RL) by leveraging a simulation built upon real-world data.

In contrast to conventional systems, such as those described, disclosed approaches may use reinforcement learning to train at least one machine learning model (MLM) which may additionally or alternatively refer to a machine learned model or a ML-based model, used to control a vehicle (e.g., implementing a driving policy), by leveraging a deep neural network (“DNN) trained on real-world data to predict movements of one or more actors to define a world model. For example, the DNN may be trained from real-world data to predict attributes of actors, such as locations and/or movements, from input attributes. The predictions may define states of the environment in a simulator, and one or more attributes of one or more actors input into the DNN may be modified or controlled by the simulator (e.g., using heuristics) to simulate conditions that may otherwise be unfeasible (e.g., an actor moving towards the vehicle). The MLM(s) may leverage predictions made by the DNN to predict one or more actions for the vehicle. These predictions may be extrapolated using a classical prediction model after the DNN. The states of the environment may be used to assign a score(s) to the predictions made by the MLM using a value function, which may be based on a goal(s) of the MLM. In one or more embodiments, the value function may be learned by one or more MLMs. The trained MLM(s) may then be deployed in an autonomous vehicle for use in predicting and/or controlling actors in traffic (and other real-world situations), which may include predicting the movements of the ego-vehicle and/or other actors.

### BRIEF DESCRIPTION OF THE DRAWINGS

The present systems and methods for model-based reinforcement learning for behavior prediction are described in detail below with reference to the attached drawing figures, wherein:

FIG. 1A is a diagram showing an example of a model training system, in accordance with some embodiments of the present disclosure;

FIG. 1B is a diagram showing an example of prediction being used in the planning and control of an autonomous vehicle, in accordance with some embodiments of the present disclosure;

FIG. 2 is a diagram showing a visualization of example inputs and outputs of a prediction machine learning model, in accordance with some embodiments of the present disclosure;

FIG. 3 is a diagram illustrating the encoding and decoding of a latent space of a prediction neural network, in accordance with some embodiments of the present disclosure;

FIG. 4 includes an example data flow diagram for a process of predicting trajectories of one or more actors in an environment, in accordance with some embodiments of the present disclosure;

FIG. 5 depicts an example deep neural network (DNN) architecture suitable for implementation in at least one embodiment of the process of FIG. 4, in accordance with some embodiments of the present disclosure;

FIG. 6 depicts a visual representation of example trajectories of actors overlaid on a map, in accordance with some embodiments of the present disclosure;

FIG. 7 illustrates an example of extending a predicted path using a classical mechanical motion algorithm, in accordance with some embodiments of the present disclosure;

FIG. 8 is a flow diagram showing a method for training a machine learning model to make predictions using actor locations predicted using a DNN, in accordance with some embodiments of the present disclosure;

FIG. 9 is a flow diagram showing a method for training a machine learning model to make predictions using a DNN as a world model, in accordance with some embodiments of the present disclosure;

FIG. 10 is a flow diagram showing a method for controlling an autonomous vehicle based upon predictions, in accordance with some embodiments of the present disclosure;

FIG. 11A is an illustration of an example autonomous vehicle, in accordance with some embodiments of the present disclosure;

FIG. 11B is an example of camera locations and fields of view for the example autonomous vehicle of FIG. 11A, in accordance with some embodiments of the present disclosure;

FIG. 11C is a block diagram of an example system architecture for the example autonomous vehicle of FIG. 11A, in accordance with some embodiments of the present disclosure;

FIG. 11D is a system diagram for communication between cloud-based server(s) and the example autonomous vehicle of FIG. 11A, in accordance with some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

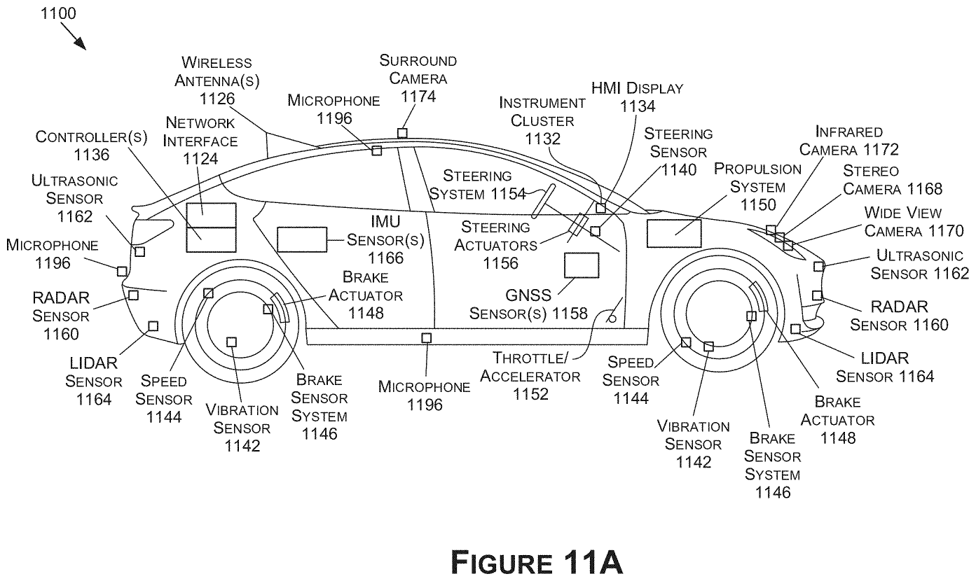

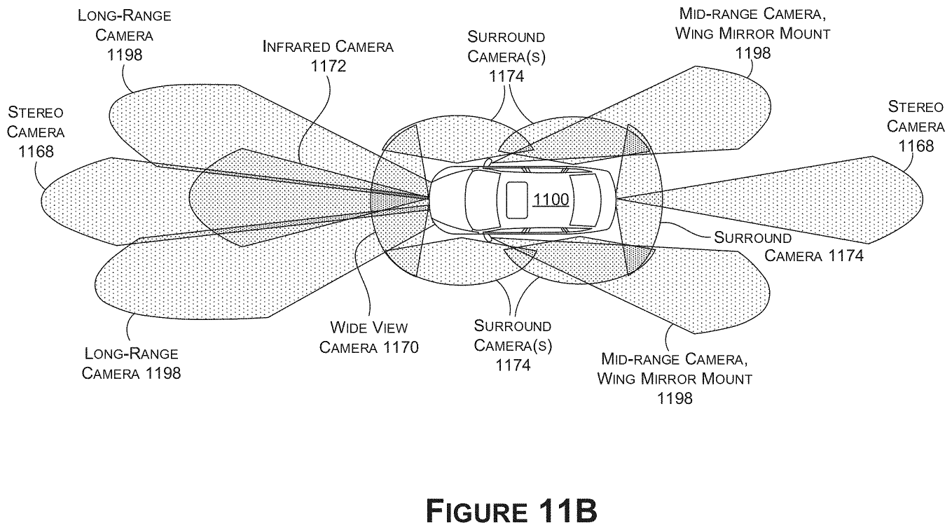

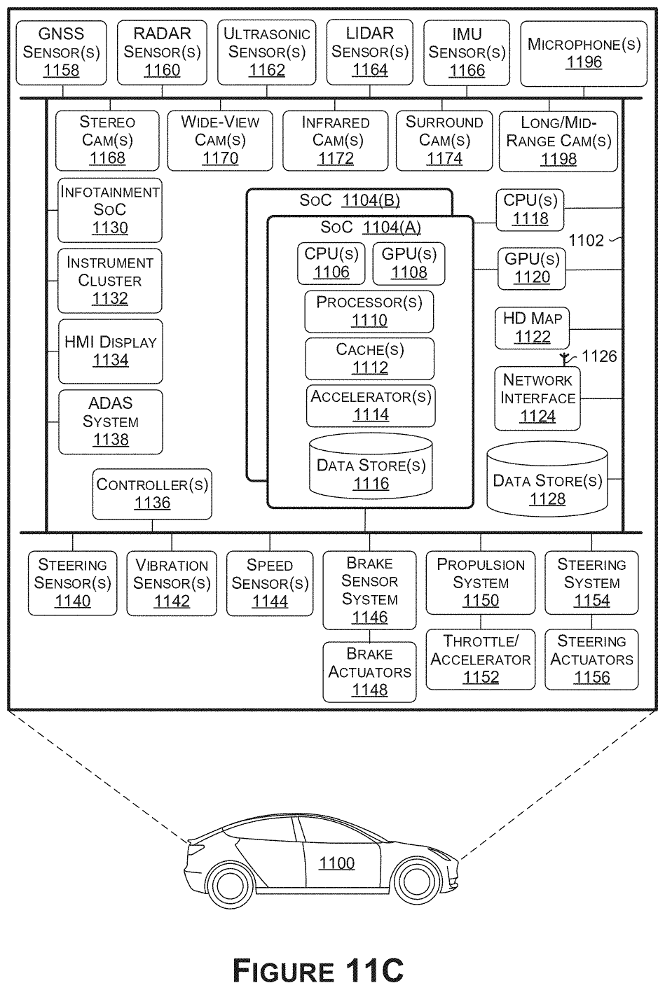

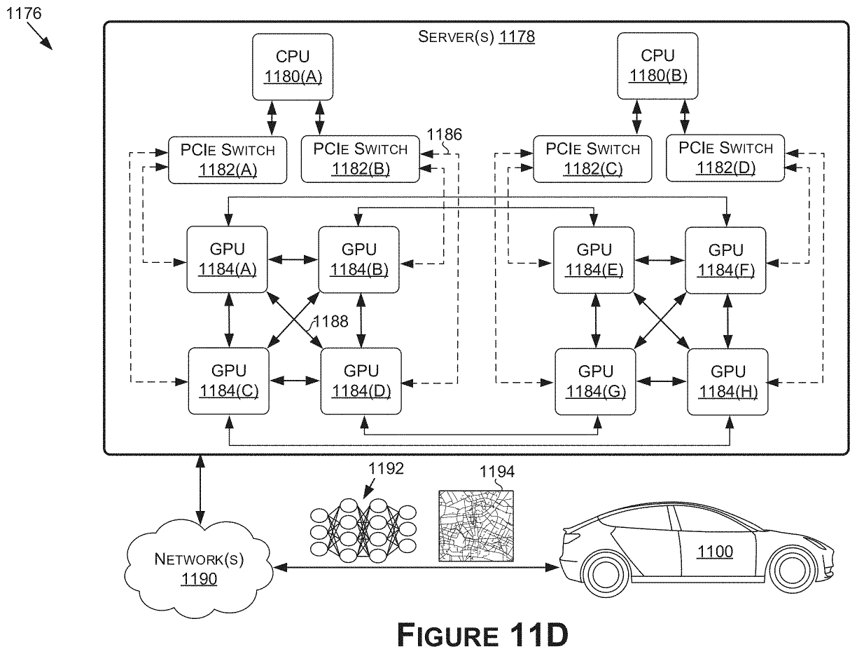

Systems and methods are disclosed related to model-based reinforcement learning for behavior prediction. Although the present disclosure may be described with respect to an example autonomous vehicle 1100 (alternatively referred to herein as “vehicle 1100” or “ego-vehicle 1100,” an example of which is described with respect to FIGS. 11A-11D), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to behavior prediction for autonomous vehicles, this is not intended to be limiting, and the systems and methods described herein may be used in augmented reality, virtual reality, mixed reality, robotics, security and surveillance, autonomous or semi-autonomous machine applications, and/or any other technology spaces where predictions may be used.

Before being used to train at least one MLM (which may also be referred to herein as a policy network) to predict one or more actions for a vehicle, a DNN or other MLM (which may also be referred to herein as a prediction network) may be trained to predict one or more output attributes of one or more actors (which may include the ego-vehicle and/or one or more other actors in a vicinity of the ego-vehicle) from one or more input attributes.

In one or more embodiments, a set of training data used to train the DNN may be generated using one or more real-world vehicle sensors indicative of movements of the one or more actors in the environment over a period of time. The set of training data may be generated using any combination of various types of vehicle sensors (such as cameras, LiDAR sensors, radar sensors, etc.) from various different vehicles in numerous different real-world situations. Traffic is difficult to model, so real-world sensor data may be used to train the DNN to learn how the actors will change. For example, trajectories for the actor(s) may be extracted from the real-world data and used to define inputs to the DNN, as well as ground truth data. In one or more embodiments, the set of training data may include or otherwise be associated with data related to the movements of the ego-vehicle. This is because movements of the ego-vehicle may affect the movements of other actors around the ego-vehicle and because the movements of the ego-vehicle may also be predicted as discussed herein.

Once trained (e.g., to predict movements of actors in traffic), the DNN may be used to define a world model in a simulation to apply Reinforcement Learning (RL) to train the policy network. For example, predictions made by the DNN may define states of the environment represented in the simulation. In one or more embodiments, the trained DNN may be used as a traffic model in the simulation. The policy network may also be trained to make predictions of one or more actions for the vehicle (e.g., predict one or more trajectories for the vehicle) based on the predictions made by the DNN. For example, the policy network may learn how to make predictions of one or more trajectories of one or more actors through training in the simulation. In one or more embodiments, the simulation may modify or control one or more attributes of one or more actors in the states of the world model that are input into the DNN in order to simulate actions taken by those actors (e.g., a vehicle moving towards the vehicle, the vehicle driving on the side of a road, unsafe driving conditions, etc.). Thus, the policy network may learn from simulated situations which may otherwise be unavailable or sparse in real-world training data.

RL techniques can be used with this simulation to train the policy network according to one or more policies. For example, a policy network may learn how to plan the best action(s) for the vehicle given a goal(s) (e.g., as an input or implicit in training) and traffic information encoded by the DNN. Examples of goals may include reaching a certain destination, following another vehicle, etc. When a motion planner that leverages predictions made by the policy network chooses one or more actions, it may interact with the traffic model and the predicted future trajectories (e.g., future traffic motions for other actors) and may change or update the actions accordingly. This way possibilities in the simulator can be replayed for all possible futures that depend on the actions of the planner, and the policy network can be trained to reach optimal states (and/or avoid bad states) given the goal.

In one or more embodiments, the planner/policy network(s) may be trained using an internal latent state of the DNN as its world state representation, allowing training to be simplified. The simulator may iterate through the environment step-by-step by using the DNN to generate predictions in a latent space then decoding the predictions into the metric real-world space, moving one or more of the actor(s) according to the predictions and one or more physical models, then encoding the changed world again into the latent space for re-predicting during the next step. In this manner, the planner/policy network(s) may learn to infer the best action(s) (e.g., trajectory) for a vehicle given its current goal (e.g., a target to reach on a map) and a current traffic situation (and its past in some embodiments) encoded as a latent space vector of the DNN.

In one or more embodiments, reinforcement learning used to train a policy network may apply a value function, which may be evaluated based at least on one or more of the states of the environment predicted by the DNN, to assign a score(s) to the predictions made by the MLM. For example, rewards may be associated with one or more goals of the policy network and penalties may be associated with collisions or other predicted or inferred states of the network. In one or more embodiments, the value function may include one or more state value functions and/or q-functions, and states of the value function may correspond to times and locations in the latent space of the DNN. In one or more embodiments, reinforcement learning may be implemented, at least in part, using an actor-critic algorithm. For example, the policy network may serve as an actor and a value function network, trained to predict the scores of the value function, may serve as a critic.

Once the policy network and/or a value function is sufficiently trained, the policy network and/or the value function may be used to plan and/or control an autonomous vehicle in real-world situations. For example, the network(s) may be used to make predictions (e.g., frame-by-frame) which may be used by a motion planner to control the vehicle. As an example, a policy network may predict one or more trajectories for one or more actors (e.g., an object and/or the autonomous vehicle) based on a state of the environment input into the DNN. The motion planner may use the corresponding predicted trajectory(ies) as a trajectory for the vehicle and/or to determine and/or evaluate one or more trajectories for the vehicle. Additionally or alternatively, where a value function network is provided, the value function network may be used to determine and/or evaluate one or more trajectories for the vehicle. In one or more embodiments, where trajectories are predicted, the trajectory may be extended using a classical mechanical motion algorithm to generate an extended trajectory (e.g., during training and/or deployment). In one or more embodiments, the classical mechanical motion algorithm may extend the trajectory in a direction of travel of the actor based on the velocity, acceleration, and/or other outputs predicted by the MLM(s). The classical portion may be less computationally intensive than the MLM-predicted portion(s) of the trajectory and/or may allow for shorter MLM-based predictions, as the accuracy of these predictions may decrease over time. Further, the extended trajectory may be more readily used by a classical planner and/or controller of the vehicle.

In one or more embodiments, the DNN may be trained at least partially using one or more supervised learning techniques, which may include (for example and without limitation) imitation learning. One potential drawback of traditional imitation learning is that conventional implementations often have difficulty handling rare and/or unsafe events. These rare and/or unsafe events may not be properly captured in the training data, thus inadequately preparing the model for the rare and/or unsafe events. Examples of such rare and/or unsafe events may include vehicle cut-ins and harsh braking that might lead to collisions. To address these issues, one or more embodiments of the disclosure use a model-based reinforcement learning framework and formulate the driving problem as a Markov Decision Process (MDP) with the DNN as the transition model. Embodiments of the present disclosure may train an additional policy network to produce ego actions.

Embodiments of the present disclosure may thus be better prepared to handle these rare and/or unsafe events (for example, cut-ins and collisions caused by harsh braking) which were difficult for traditional adaptive cruise control (ACC) solutions. As an example, an iteration may include a plurality of vehicles including a lead car, a neighbor car, and the ego car. A randomized initial state may be used for the simulation. The non-ego vehicle may be controlled by a prediction network, while the ego car may be controlled by the reinforcement learning policy network. In an example of a rare and/or unsafe event, the neighbor car may execute a cut-in move when it observes a gap between the lead car and the ego car. In another example of a rare and/or unsafe event, the lead car executes a random harsh braking event.

Embodiments of the present disclosure may learn a policy that maps the state at a certain time to a certain action, such as an ego-vehicle acceleration. A task reward may be defined by a sum of manually designed reward terms such as distance to the lead car, acceleration changes, etc., as well as a sparse penalty term accounting for the rare events such as cut-ins and collisions. The trained RL policy may thus, over iterations, learn to plan so as to reduce the gap and avoid cut-ins, and to keep a slower speed and avoid future harsh braking.

In some embodiments of the present disclosure, the DNN may use a soft actor critic algorithm (SAC) to train the policy and critic networks, while keeping trunk weights constant. A latent vector may be fed into three fully convolutional layers to extract features, in which each of the policy and critic networks may be a three-layer multilayer perceptron (MLP). As an example, an MDP discount factor may be used, such as (without limitation) 0.95. The ACC reward function may denote the changes in acceleration and velocity, the distance to the lead car, and may be tuned to accomplish smooth following in real-world scenarios. Various iterations may begin with randomized initial conditions. An iteration may end if a collision or cut-in happens with a task-specific penalty, or reaches the maximum number of iteration steps (for example, forty-eight), or upon some other criteria.

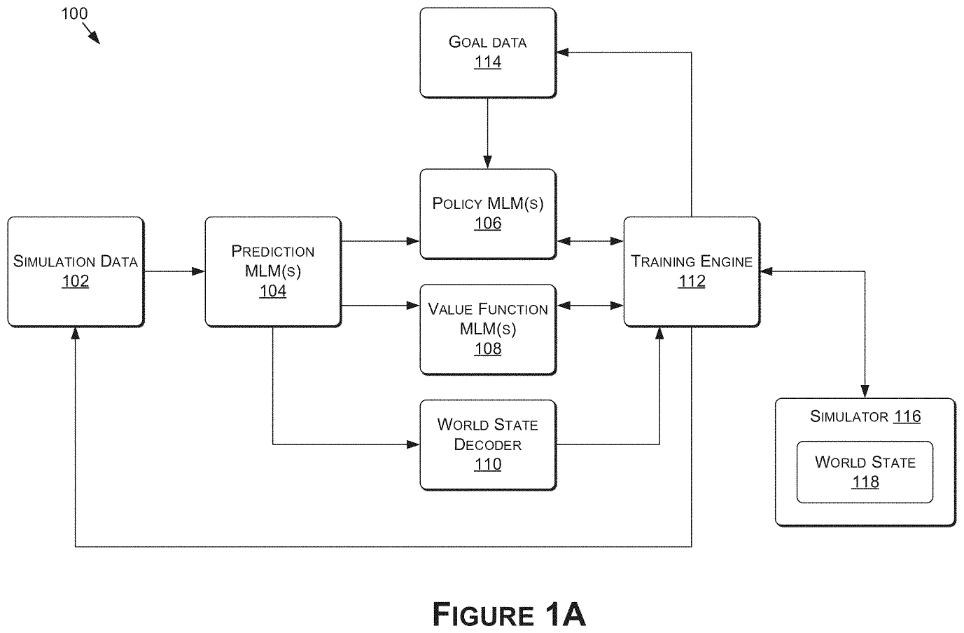

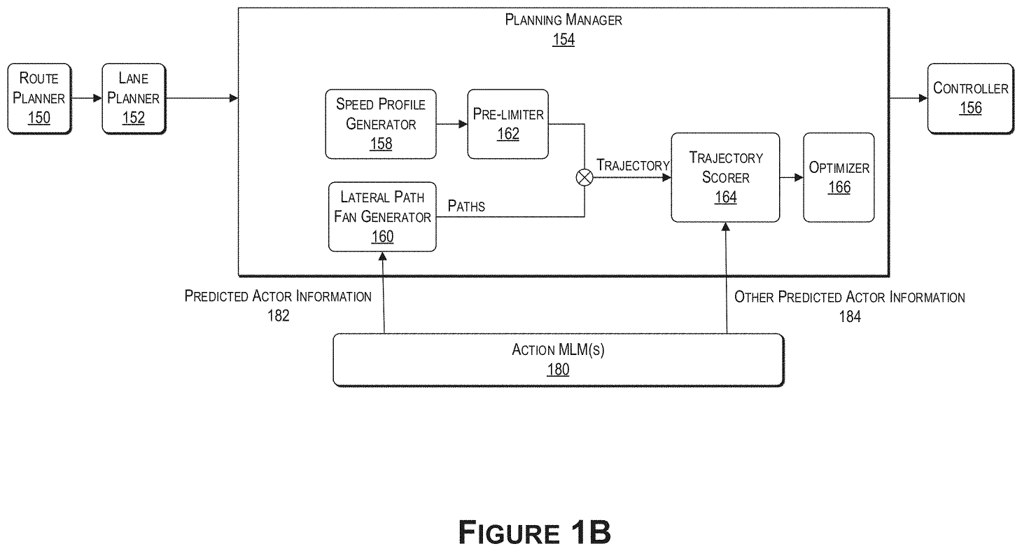

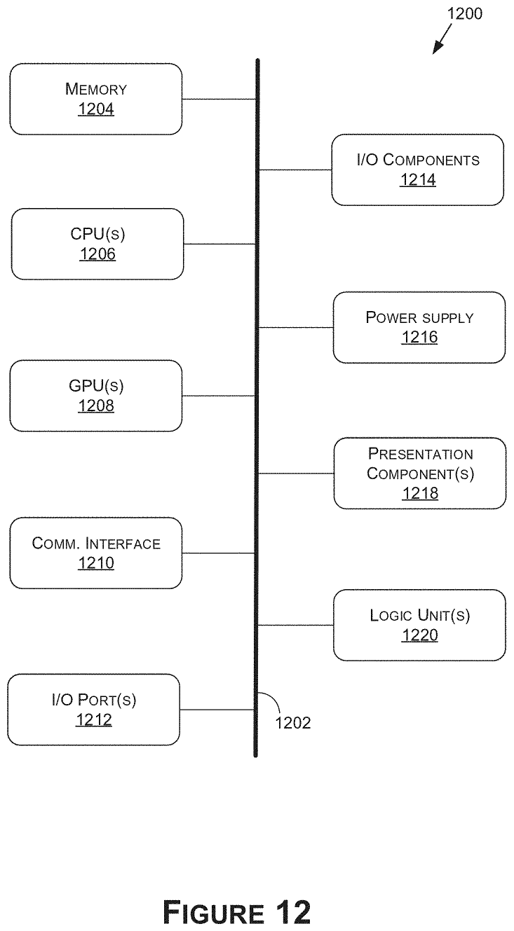

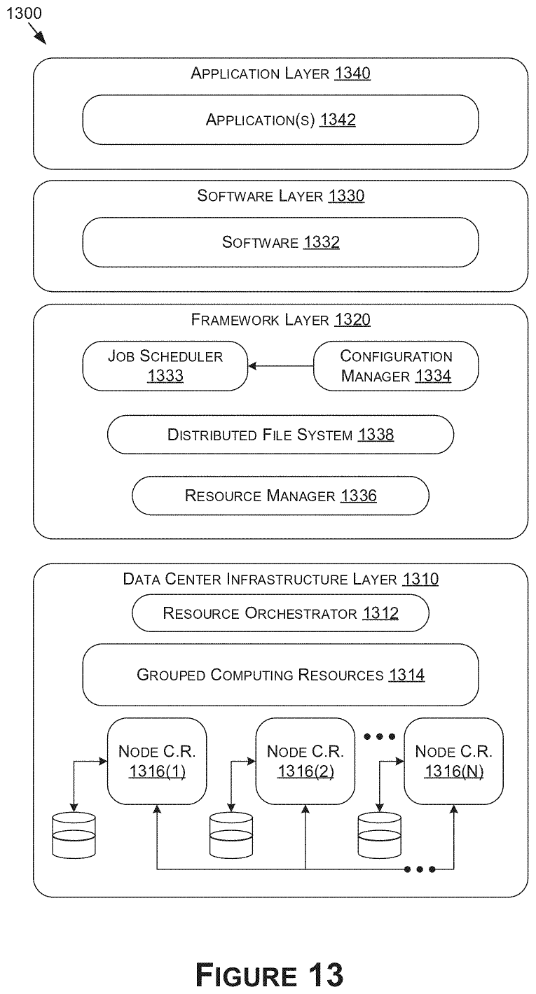

With reference to FIG. 1A, FIG. 1A is an example model training system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1100 of FIGS. 11A-11D, example computing device 1200 of FIG. 12, and/or example data center 1300 of FIG. 13.

FIG. 1A shows the model training system 100 which may be used to train a policy MLM 106 using a trained prediction MLM 104 to define a world model. As an overview, the model training system 100 may implement an iterative approach to training the policy MLM 106; in one or more embodiments an iterative approach may also be used to train a value function MLM 108. An iteration may include the training engine 112 applying simulation data 102 generated using a simulator 116 to the prediction MLM 104 to generate output data. The policy MLM 106 may use data corresponding to the output from the prediction MLM 104 to generate one or more predictions corresponding to one or more actions for a vehicle, such as the vehicle 1100. The value function MLM 108 may also use data corresponding to the output from the prediction MLM 104 to generate one or more predictions corresponding to one or more scores for the one or more actions predicted using the policy MLM 106. A world state decoder 110 may also use data corresponding to the output from the prediction MLM 104 to provide input to the training engine 112. For example, the world state decoder 110 may decode a latent space of the prediction MLM 104 into the metric real-world space. The training engine 112 may use the decoded data to evaluate the performance of the policy MLM 106 and/or the value function MLM 108 and update one or more parameters thereof. The training engine 112 may additionally or alternatively use the decoded data to define a world state 118 used to generate the simulation data 102 for a subsequent iteration.

In one or more embodiments, the training engine 112 may score the performance of the policy MLM 106 (which in at least one embodiment may be based upon goal data 114 provided from the training engine 112) and/or the value function ML 108 based at least on output data generated by one or more of those MLMs. Based on the scoring, the policy MLM 106 and/or the value function MLM 108 may be updated or revised (e.g., using backpropagation and/or other suitable MLM training techniques).

In one or more embodiments, the training engine 112 may provide updated simulation data 102 and/or updated goal data 114 for a subsequent iteration of the training. The updated simulation data 102 and/or the updated goal data 114 may be provided, directly or indirectly, by the simulator 116 and may reflect the world state 118. The simulator 116 may include a software application that stores and models the world state 118 based at least on outputs from the prediction MLM 104, which the simulator 116 may use to provide an accurate simulation of real-world conditions. For example, the world state 118 may record locations, attributes, and/or other predictions for one or more actors made by the prediction MLM 104 based at least on a previous world state 118 encoded by the simulation data 102. In one or more embodiments, the training engine 112 may use one or more physical models and/or heuristics to control one or more of the actors and adjust the locations, attributes, and/or other actor state information recorded to the world state 118 and/or indicated by the simulation data 102. For example, at least one actor may be controlled, at least in part, using the simulator 116 with the prediction MLM 104 being used to predict changes to the world state caused by the actor(s) (e.g., predict trajectories of one or more other actors based on the controlled or influenced actor).

In one or more embodiments, the training engine 112 may compute a cost or value metric over any number of iterations of the prediction MLM 104 being used to predict at least a portion of the world state and/or the simulator 116 controlling or influencing the actor. This cost or value metric may be used to update the policy MLM 106 and/or the value function MLM 108. For example, the value metric may be used to train the policy MLM 106 to attempt to maximize the value metric and may be used to train the value function MLM 108 to predict the value metric. In this way, the simulator 116 may be used to simulate dangerous or impractical scenarios or to otherwise train the policy MLM 106 and/or the value function MLM 108 without requiring real-world data.

In one or more embodiments, the simulator 116 and/or the training engine 112 may be implemented, at least in part, using software, such as a toolkit, that provides an environment and a framework for simulating the environment over a plurality of time steps using, for example, a physics engine and/or predictions made by the prediction MLM 104. In one or more embodiments, the simulator 116 include an RL gym. A non-limiting example of such software includes OpenAI Gym. In one or more embodiments, each time step may correspond to one or more iterations of training the policy MLM 106 and/or the value function MLM 108. In one or more embodiments, each time step may correspond to one or more points on one or more trajectories predicted using the prediction MLM 104 for one or more actors. In one or more embodiments, each time step may correspond to a state which may be scored by the training engine 112 using the value metric.

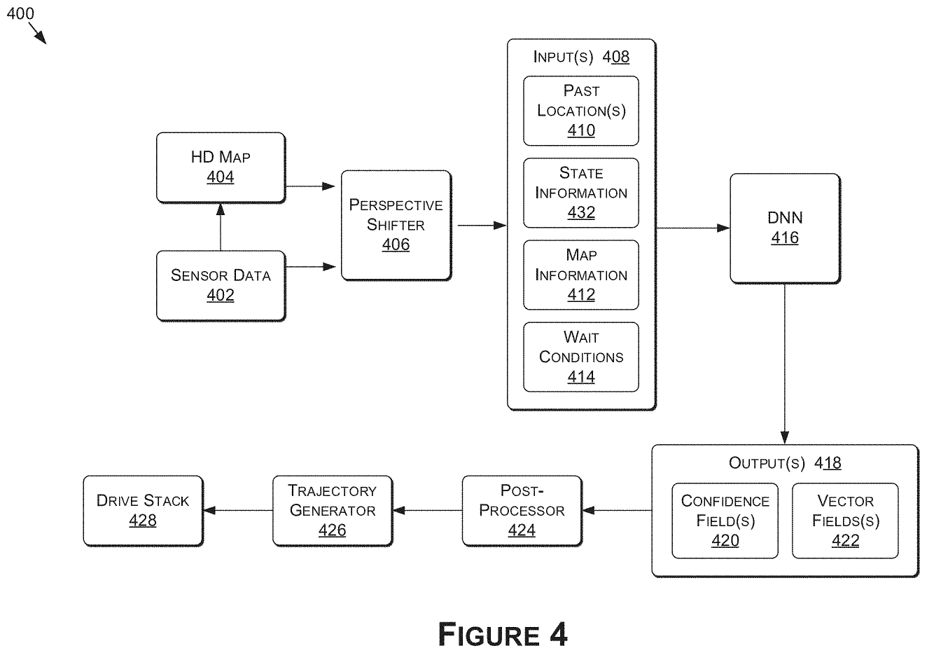

In one or more embodiments, the prediction MLM 104 may receive as input one or more locations and/or other attributes (e.g., velocity, acceleration, trajectory, etc.) for one or more actors encoded in the simulation data 102. In various examples, the one or more actors may include the ego-vehicle and/or one or more other vehicles or objects (e.g., a mobile object and/or actor such as a pedestrian, a cyclist, an animal, etc.). The prediction MLM 104 may use the inputs to make one or more predictions regarding the one or more locations and/or other attributes (e.g., velocity, acceleration, trajectory, etc.) for the one or more actors. Non-limiting examples of such predictions may include a future value(s) of any of those attributes for one or more future time steps. By way of example and not limitation, in one or more embodiments the prediction MLM 104, the policy MLM 106, and/or the value function MLM 108 may be implemented as or may include a DNN 416 further described with respect to FIG. 4.

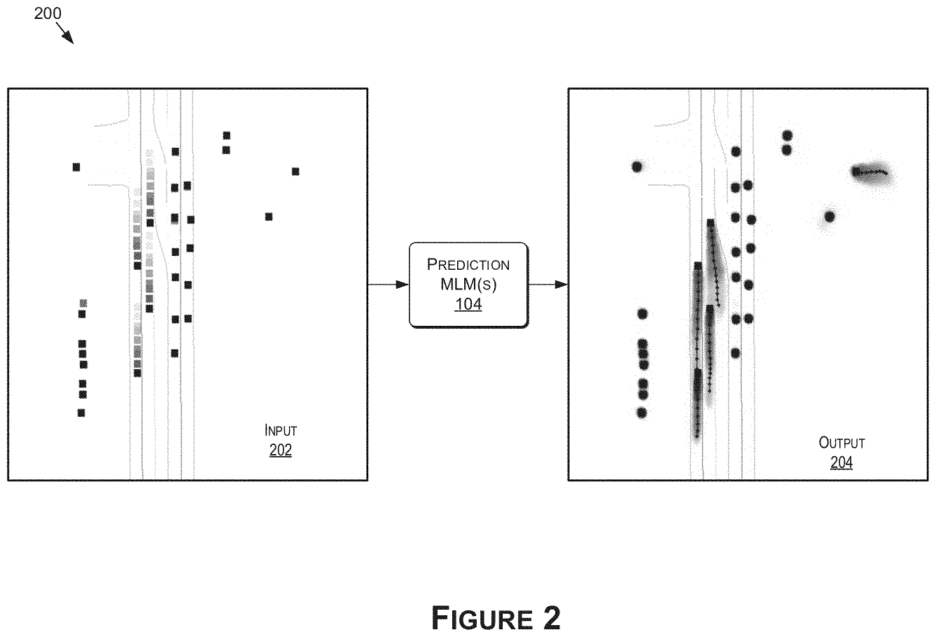

Referring now to FIG. 2, FIG. 2 is a diagram showing a visualization 200 of example inputs and outputs of the prediction MLM 104, in accordance with some embodiments of the present disclosure. The visualization 200 illustrates how a set of inputs 202 may be provided to the prediction MLM 104 to produce a set of outputs 204. The set of inputs 202 are indicated in FIG. 2 using a top-down image of the environment, by way of example, and not limitation. In one or more embodiments, input attributes may be provided in a coordinate space referenced to the top-down view or a different view. Object locations may be indicated by squares (e.g., each corresponding to a time step), one or more of which may be associated with and/or assigned to a particular actor. For example, object locations are shown in black, with corresponding past locations for the objects shown in grey scale (with past locations further back in time shown in lighter grey). Stationary objects may be shown in black with no corresponding greyscale. This set of inputs 202 may allow for the prediction MLM 104 to account for the current and past locations of one or more actors (which may include an ego-vehicle). Velocities and accelerations may be indicated by spacing between time steps and/or may be encoded to one or more time steps.

The prediction MLM 104 may use the set of inputs 202 to infer a trajectory for each actor that is indicated by the set of outputs 204. As an example, FIG. 2 depicts a visual representation of example trajectories in the top-down view, in accordance with some embodiments of the present disclosure. The set of outputs 204 may include location coordinates and/or other associated predicted attributes (e.g., the same or different than the input attributes) for any number of time steps. For example, in FIG. 2, a connected path of location points may correspond to a predicted trajectory for an actor, with each point corresponding to a respective time step. A darker gradient shown for the set of outputs 204 may indicate less uncertainty in the predictions and a light gradient may indicate more uncertainty. The training engine 112 and/or the simulator 116 may associate any of this various information with map information (e.g., after decoding is performed using the world state decoder 110), such as lane information, as indicated by the lane lines and trajectories for various actors.

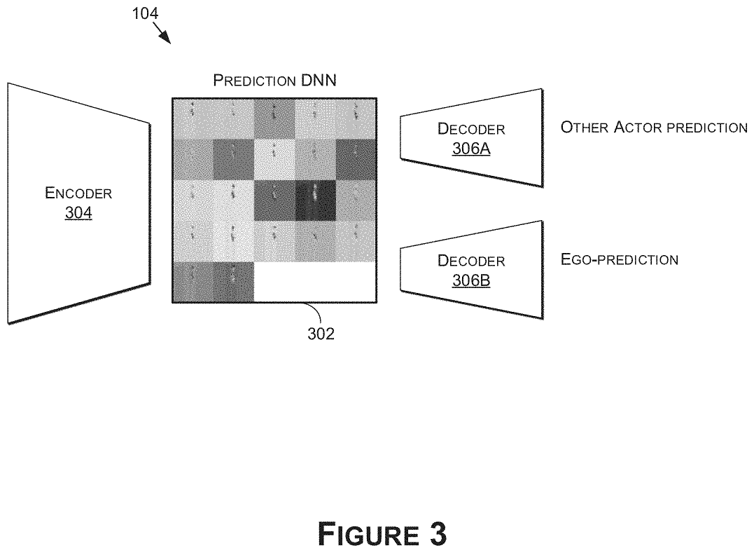

In one or more embodiments, output data from the prediction MLM 104 may be used to train one or more other MLMs, such as the policy MLM 106 and the value function MLM 108. In at least one embodiment, one or more portions of the policy MLM 106 and/or the value function MLM 108 may be a component of the prediction MLM 104. For example, the policy MLM 106 and/or the value function MLM 108 may include at least in part one or more heads or decoders of the prediction MLM 104, as further described with respect to FIG. 3.

Referring now to FIG. 3, FIG. 3 is a diagram illustrating the encoding and decoding of a latent space 302 of the prediction MLM 104, in accordance with some embodiments of the present disclosure. FIG. 3 shows the prediction MLM 104 (e.g., a neural network) may include an encoder 304 for encoding the simulation data 102 to the latent space 302. FIG. 3 also shows the prediction MLM 104 may include one or more decoders, such as a decoder 306A and/or a decoder 306B for decoding the latent space 302 to produce one or more various outputs. For example, the decoder 306A and the decoder 306B may correspond to at least a portion of the policy MLM 106. As shown, the decoder 306A may predict one or more attributes of one or more other objects or actors and the decoder 306B may predict one or more attributes of an ego-actor, such as the vehicle 1100. Additionally or alternatively, the value function MLM 108 may similarly be implemented, at least in part, using a decoder of the latent space 302.

However, the policy MLM 106 and/or the value function MLM 108 need not be a component of the prediction MLM 104 and may be separate from the prediction MLM 104. For example, in one or more embodiments, the world state decoder 110 and/or a different post-processing unit may be used to generate inputs to the policy MLM 106 and/or the value function MLM 108. Thus, in at least one embodiment, the policy MLM 106 and/or the value function MLM 108 may operate based on the latent space 302 of the prediction MLM 104 without receiving and/or decoding at least a portion of the latent space.

In one or more embodiments, the policy MLM 106 may be trained to make a goal-based prediction based at least on output data from the prediction MLM 104. For example, the goal data 114 may be used by the training engine 112 to encode one or more goals for the policy MLM 106. The policy MLM 106 may then be trained by the training engine 112 to make predictions in order to achieve one or more corresponding goals. For example, the goal data 114 may be provided to the policy MLM 106 and/or the value function MLM 108 for use in making inferences. However, in at least one embodiment, the goal data 114 need not be used to train the policy MLM 106 and/or the value function MLM 108 to make goal-based predictions. Rather, the one or more goals may be captured by the value function used to train the policy MLM 106 and/or the value function MLM 108.

As described herein, the policy MLM 106 may be trained to make one or more predictions corresponding to one or more actions to be taken by one or more actors. For example, the policy MLM 106 may predict a trajectory and/or location for an actor to traverse, such as the vehicle 1100. In doing so, the policy MLM 106 may account for the one or more goals. Examples of goals, which may optionally be encoded to the goal data 114, include being able to successfully reach or achieve a given path, lane, position, or other actor attribute and/or aspects of a world state (e.g., velocity, acceleration, orientation, pose, etc.), being able to successfully avoid collision, and/or being able to successfully achieve an attribute or state relative to another actor's attribute or state (e.g., move in front of the other actor). The policy MLM 106 may thus be trained to make predictions aimed at achieving one or more attributes and/or world states, such that the goal(s) may be met.

As described herein, the training engine 112 may evaluate the performance of the policy MLM 106 and/or the value function MLM 108 and update one or more of those networks accordingly using reinforcement learning. For example, the training engine 112 may use the value function to determine one or more scores indicative of the performance of the policy MLM 106 and/or the value function MLM 108 over one or more time steps and/or iterations of incrementing the world state 118 using the prediction MLM 104 and/or the simulator 116. This may include the training engine 112 calculating or assigning one or more scores to one or more predictions made by the policy MLM 106 and/or the value function MLM 108. Based upon the score(s), the training engine 112 may determine if one or more parameters of the policy MLM 106 and/or the value function MLM 108 should be updated or revised. The training engine 112 may then instruct, change, or otherwise provide an indication of the one or more parameters to be updated or revised. The one or more parameters of the at least one MLM may then be updated based at least on the one or more scores.

As described herein, the value function may be computed based at least on the training engine 112 evaluating the world state 118 and/or predictions made by the prediction MLM 104 regarding the world state 118 to determine or identify one or more events using the output(s) of the prediction MLM 104. For example, the training engine 112 may determine, from one or more subsequent state of the environment, a collision of the ego-vehicle (and/or other actors) in the environment. The one or more scores of the value function calculated by the training engine 112 may be based upon the one or more events, e.g., based at least on the determining of the collision (e.g., the policy MLM 106 may be penalized based on determining a collision would occur or is more likely to occur). In one or more embodiments, an event may correspond to or represent a goal to be achieved by the policy MLM 106, as described herein (e.g., reach a location, achieve a world state or attribute, etc.). In one or more embodiments, the value function may be computed based at least on a proximity to the event (e.g., a distance to a given location, a distance to a target attribute value, etc.). In one or more embodiments, the value function may include one or more state value functions and/or q-functions and states of the value function may correspond to times and locations in the latent space of the DNN (e.g., the time steps). In one or more embodiments, reinforcement learning may be implemented, at least in part, using an actor-critic algorithm. For example, the policy MLM 106 may serve as an actor and the value function MLM 108, trained to predict the scores of the value function, may serve as a critic.

As described herein, the training engine 112 may use the simulator 116 in evaluating the performance of the prediction MLM 104 and/or the value function MLM 108. For example, the training engine 112 may use the simulator 116 to detect events and/or attributes in the world state 118. In one or more embodiments, the simulator 116 may use a physics engine to determine and/or detect one or more of the events and/or attributes used to compute the value function for one or more states or time steps. This may include forward projecting one or more aspects of the world state 118 (e.g., over any number of iterations or time steps) using at least a portion of the one or more actions predicted using the policy MLM 106. Additionally or alternatively, the simulator 116 may use the prediction MLM 104 to forward project one or more aspects of the world state 118 (e.g., over any number of iterations or time steps) using at least a portion of the one or more actions predicted using the policy MLM 106. In one or more embodiments, the prediction MLM 104 may be used by the simulator 116 to drive traffic step-by-step, moving actors in the world state 118 according to predictions for each iteration. The simulator 116 may re-draw the world according to the updated world state 118 and perform collision checks and evaluate dynamics of the actors for use in the value function. In at least one embodiment, the simulator 116 may interpolate between one or more of the steps to provide higher frequency evaluations. In one or more embodiments, the simulator 116 may control one or more of the actors using the physics engine and/or heuristics when performing the forward projection.

In one or more embodiments, a cycle or iteration may include providing the simulation data 102, making one or more predictions using the prediction MLM 104, the policy MLM 106, and the value function MLM 108, evaluating the predictions made by the policy MLM 106 and/or the value function MLM 108, and/or updating one or more parameters of the policy MLM 106 and/or the value function MLM 108 based on the evaluation. At or during each iteration, the simulator 116 may incrementally move forward the world state 118 (e.g., by one or more time steps), providing an updated set of the simulation data 102 and/or the goal data 114 for another iteration of the training until the policy MLM 106 and/or the value function MLM 108 converge.

Referring now to FIG. 1, FIG. 1B is a diagram showing an example of prediction being used in the planning and control of the autonomous vehicle 1100, in accordance with some embodiments of the present disclosure. As shown, the vehicle 1100 may use a route planner 150, a lane planner 152, the planning manager 154, and a controller 156 to perform one or more planning and control operations. One or more of these components may be included, at least in part, in a drive stack 428 discussed herein.

FIG. 1B shows an action MLM(s) 180, which may refer to any combination of the policy MLM 106, the value function MLM 108, or the prediction MLM 104. For example, predicted actor information 182 may correspond to, for an ego-actor, a predicted action (e.g., trajectory) determined by the policy MLM 106 and/or a predicted value metric determined by the value function MLM 108. Other predicted actor information 184 may correspond to, for one or more other actors, a corresponding predicted action (e.g., trajectory) and/or attribute determined by the prediction MLM 104 and/or the policy MLM 106 (e.g., the decoder 306A). When implemented in the autonomous vehicle 1100, the action MLM 180 may be used to predict the predicted actor information 182 and/or the other predicted actor information 184 in order to inform a planning manager 154 of the vehicle 1100.

The route planner 150 may generate a planned path for the vehicle 1100 based upon various real or simulated inputs. The planned path may include waypoints (e.g., GPS waypoints), destinations, coordinates (e.g., Cartesian, polar, or other world coordinates), or other reference points. The reference points may indicate coordinates relative to an origin point on the vehicle 1100, etc. The reference points may be representative of a specific distance into the future for the vehicle 1100, such as a number of city blocks, a number of kilometers, a number of feet, a number of inches, a number of miles, etc., that may be used as a target for the lane planner 152.

The lane planner 152 may use a lane graph, object poses within the lane graph, and/or a target point and direction at the distance into the future from the route planner as inputs. The target point and direction may be mapped to the best matching drivable point and direction in the lane graph (e.g., based on GNSS and/or compass direction). A graph search algorithm may then be executed on the lane graph from a current edge in the lane graph to find the shortest path to the target point.

The planning manager 154 may use the action MLM 180 to predict movements for the ego-vehicle and/or other actors in vicinity of the ego-vehicle, and/or a value metric for one or more ego-vehicle actions. The planning manager 154 may include a speed profile generator 158, a lateral path fan generator 160, a pre-limiter 162, a trajectory scorer 164, and an optimizer 166. The speed profile generator 158 may determine speeds based upon lateral separation between two or more subsequent locations for the actor, divided by a time interval between the subsequent locations. The speed profiles may be used, at least in part, to predict the future actions of associated actors using the action MLM 180. The lateral path fan generator 160 may determine a lateral path fan for an ego-vehicle, based upon predictions from the action MLM 180. A lateral path fan may be indicative of likely lateral motions that the ego-vehicle may continue. The pre-limiter 162 may reduce the less likely outputs such that unlikely paths (e.g., drastic changes in speed and/or direction) may be discarded to reduce the overall computational load. Trajectories and/or predicted other actions may be fed into the trajectory scorer 164. The trajectory scorer may evaluate and assign scores to one or more of the actions. The optimizer 166 may select and/or optimize one or more control operations for the vehicle 1100 based at least on the evaluations made using the trajectory scorer 164 (e.g., select a trajectory based on a corresponding score and used the trajectory to optimize the one or more control operations).

The controller 156 may cause control of the vehicle 1100 in accordance with a select and/or optimized path from the optimizer 166. In some embodiments, the controller 156 may directly control the actions of the vehicle 1100, such as accelerating, braking, turning, etc. For example, the controller 156 may control a brake actuator 1148, a propulsion system 1150 and/or throttle 1152, a steering system 1154 and/or steering actuator 1156, and/or other components of the vehicle 1100 (such as illustrated in FIG. 11A). In other embodiments, the controller 156 may indirectly control the actions of the vehicle 1100, such as by sending a message or instruction to another system of the vehicle 1100.

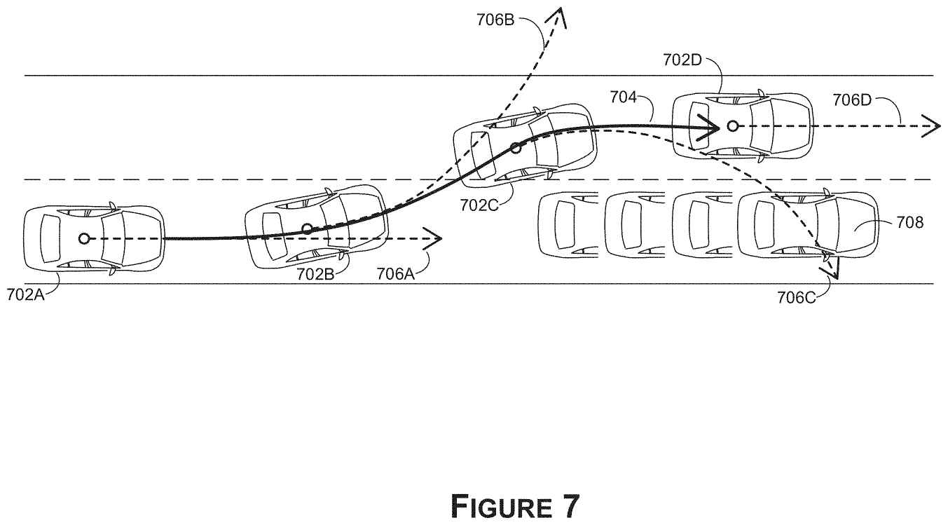

As such, the planning manager 154 may piece together the known past locations and the predicted future locations of actors and generate and/or evaluate trajectories using the action MLM 180, which may be used by a drive stack 1128 of the vehicle 1100. In one or more embodiments, a trajectory predicted, generated, and/or selected using the action MLM(s) 180 may be extended using a classical mechanical motion algorithm, examples of which are described using FIG. 7 herein. For example, for planning purposes, the planning manager 154 may extend a maximum timeframe for a prediction so as to be better used by various components of the vehicle 1100.

With reference to FIG. 4, FIG. 4 is an example data flow diagram for a process 400 of predicting trajectories of one or more actors in an environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown in FIG. 4, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 400 includes the DNN 416 which may correspond to the prediction MLM 104, the policy MLM 106, and/or the value function MLM 108 of FIG. 1A. The process 400 may include generating and/or receiving sensor data 402 from one or more sensors of the vehicle 1100. The sensor data 402 may be used by the vehicle 1100, and within the process 400, to predict future trajectories of one or more objects or actors—such as other vehicles, pedestrians, bicyclists, etc.—in the environment. The sensor data 402 may include, without limitation, sensor data 402 from any of the sensors of the vehicle 1100 (and/or other vehicles or objects, such as robotic devices, VR systems, AR systems, etc., in some examples). For example, and with reference to FIGS. 11A-11C, the sensor data 402 may include the data generated by, without limitation, global navigation satellite systems (GNSS) sensor(s) 1158 (e.g., Global Positioning System sensor(s)), RADAR sensor(s) 1160, ultrasonic sensor(s) 1162, LIDAR sensor(s) 1164, inertial measurement unit (IMU) sensor(s) 1166 (e.g., accelerometer(s), gyroscope(s), magnetic compass(es), magnetometer(s), etc.), microphone(s) 1196, stereo camera(s) 1168, wide-view camera(s) 1170 (e.g., fisheye cameras), infrared camera(s) 1172, surround camera(s) 1174 (e.g., 360 degree cameras), long-range and/or mid-range camera(s) 1198, speed sensor(s) 1144 (e.g., for measuring the speed of the vehicle 1100 and/or distance traveled), and/or other sensor types.

In some examples, the sensor data 402 may include the sensor data generated by one or more forward-facing sensors, side-view sensors, and/or rear-view sensors. This sensor data 402 may be useful for identifying, detecting, classifying, and/or tracking movement of objects around the vehicle 1100 within the environment. In embodiments, any number of sensors may be used to incorporate multiple fields of view (e.g., the fields of view of the long-range cameras 1198, the forward-facing stereo camera 1168, and/or the forward facing wide-view camera 1170 of FIG. 11B) and/or sensory fields (e.g., of a LIDAR sensor 1164, a RADAR sensor 1160, etc.).

The sensor data 402 may include image data representing an image(s), image data representing a video (e.g., snapshots of video), and/or sensor data representing representations of sensory fields of sensors (e.g., depth maps for LIDAR sensors, a value graph for ultrasonic sensors, etc.). Where the sensor data 402 includes image data, any type of image data format may be used, such as, for example and without limitation, compressed images such as in Joint Photographic Experts Group (JPEG) or Luminance/Chrominance (YUV) formats, compressed images as frames stemming from a compressed video format such as H.264/Advanced Video Coding (AVC) or H.265/High Efficiency Video Coding (HEVC), raw images such as originating from Red Clear Blue (RCCB), Red Clear (RCCC), or other type of imaging sensor, and/or other formats. In addition, in some examples, the sensor data 402 may be used within the process 400 without any pre-processing (e.g., in a raw or captured format), while in other examples, the sensor data 402 may undergo pre-processing (e.g., noise balancing, demosaicing, scaling, cropping, augmentation, white balancing, tone curve adjustment, etc., such as using a sensor data pre-processor (not shown)). As used herein, the sensor data 402 may reference unprocessed sensor data, pre-processed sensor data, or a combination thereof.

In addition, the process 400 may include generating and/or receiving map data from a map—such as an HD map 404 (which may be similar to the HD map 1122 of FIG. 11C)—accessible by and/or stored by the vehicle 1100. The HD map 404 may include, in some embodiments, precision to a centimeter-level of finer, such that the vehicle 1100 may rely on the HD map 404 precise instructions, planning, and localization. The HD map 404 may represent lanes, road boundaries, road shape, elevation, slope, and/or contour, heading information, wait conditions, static object locations, and/or other information. As such, the process 400 may use the information from the HD map 404—such as locations and shapes of lanes—to generate inputs 408 for DNN 416.

In addition to, or alternatively from, the sensor data 402 and/or the HD map 404, the process 400 may include generating and/or receiving (e.g., using the sensor data 402 and/or the HD map 404, in embodiments) one or more outputs from an autonomous or semi-autonomous (e.g., ADAS) driving software stack and/or any of the various components shown in FIG. 1B. For example, information generated by a perception layer, a world model management layer, a control layer, an actuation layer, an obstacle avoidance layer, and/or other layers of a software stack may be used within the process 400 for generating the inputs 408. This information may include free-space boundary locations, wait conditions, intersection structure detection, lane type identification, road shape information, object detection and/or classification information, and/or the like. As such, the sensor data 402, the HD map 404, and/or other information generated by the vehicle 1100 may be used to generate the inputs 408 for the DNN 416.

In some non-limiting embodiments, the sensor data 402, the information from the HD map 404, and/or other information (e.g., from a driving stack) may be applied to a perspective shifter 406 prior to being used as an input 408 to the DNN 416. The perspective shifter 406 may orient the data with respect to one of the actors in the environment, with respect to some location on a road surface, and/or with respect to another feature represented by the data. For example, in some embodiments, the perspective shifter 406 may shift the perspective of the data with respect to a location and/or orientation of the vehicle 1100 (e.g., an ego-vehicle, or ego-actor). As such, locations of actors or objects, the portion of the HD map 404, and/or other information to be used as an input 408 may be shifted relative to the vehicle 1100 (e.g., with the ego-vehicle 1100 at the center, at (x, y) coordinates of (0, 0), where y is a longitudinal dimension extending from front to rear of the vehicle and x is a lateral dimension perpendicular to y and extending from left to right of the vehicle.

In some embodiments, in addition to or alternatively to shifting the perspective with respect to a feature of the environment, the perspective shifter 406 may shift the perspective to a same field of view. For example, where the HD map 404 may generate data from a top-down perspective of the environment, the sensors that generate the sensor data 402 may do so from different perspectives—such as front-facing, side-facing, angled downward, angled upward, etc. As such, to generate inputs 408 that share a same perspective, the perspective shifter 406 may adjust each of the inputs 408 to a same perspective. In some non-limiting embodiments, each of the sensor data 402, the HD map 404, and/or other information may be shifted to a top-down view perspective—e.g., a perspective top-down view and/or an orthogonal top-down view. In addition, the perspective shifter 406 may aid in generating the inputs 408 such that a same or substantially similar (e.g., within centimeters, meters, etc.) portion of the environment is represented from the perspective for each instance of the inputs 408. For example, a first input (e.g., a rasterized image) representing past locations 410 of actors in the environment may be represented by a top-down perspective of a portion of the environment and a second input (e.g., a rasterized image) representing map information 412 of the environment may be represented by a top-down perspective of the portion of the environment. As a result, the DNN 416 may generate outputs 418 using any number of inputs 408 corresponding to a same general portion of the environment and thus at a similar scale. However, this is not intended to be limiting, and in some embodiments the perspectives, orientations, size, locations, and scale of the inputs 408 may differ for different input types and/or instances. In some embodiments, the DNN 416 may use live lane perception instead of or in addition to an HD map, for example, rasterized as a top-down view. The live perceived lanes (e.g., their boundaries and/or center lanes) may additionally or alternatively be derived from other perception DNNs or MLMs.

The inputs 408 may include past location(s) 410 (e.g., of actors in the environment, such as vehicles, pedestrians, bicyclists, robots, drones, watercraft, etc., depending on the implementation), state information 432 (e.g., velocity and/or acceleration data corresponding to the actors), map information 412 (e.g., as generated using the HD map 404), wait conditions 414 (e.g., generated using the sensor data 402, the HD map 404, and/or other information), and/or other inputs 408 (e.g., free-space information, static object information, etc., as determined using the sensor data 402, the HD map 404, a drive stack 428 of the vehicle 1100, and/or other information). The past location(s) 410 may include prior detected locations of vehicles, pedestrians, bicyclists, and/or other actor types in the environment. In some embodiments, the past location(s) 410 may be determined with respect to the ego-vehicle 1100 such that, during perspective shifting, the change in orientation and location with respect to the actors is accomplished more efficiently. The past location(s) 410 and/or the state information 432 may be represented by an image (e.g., a rasterized image) representative of locations of the actors. In some embodiments, each instance of the past locations 410 may include a single image and may correspond to a single time slice—e.g., an instance may capture each of the actors being tracked and/or that are detected and their current location (e.g., relative to the vehicle 1100) at the time slice. In some embodiments, each instance of the state information 432 may include a single image and may correspond to a single time slice. In other embodiments, the state information 432 may be included in the image instances along with the past locations 410. The DNN 416 may take as input one or more instances of the past locations 410 and/or the state information 432, such that DNN 416 may compute the outputs 418 using one or more instances of the past locations 410 and/or the state information 432 that correspond to locations of actors over one or more time slices (e.g., over a period of time).

For example, various inputs 408 corresponding to a time slice (which may also be referred to as a time step herein) at a time, T₁, may include past locations (and/or may include the state information 432 corresponding thereto). As such, each of the squares in FIG. 2 may correspond to a location and/or state information of an actor in the environment—including the ego-vehicle 1100, in embodiments. Similarly, for a time slice at a time, T₂, actors may be detected at locations within the environment. As a non-limiting example, the locations of each actor may be oriented with respect to an ego-actor—which may be the centrally located actor—such that the DNN 416 may be conditioned on the ego-actor.

The map information 412 may include locations of lanes (e.g., lane center-lines or rails, lane edges or dividers, road boundaries, emergency lanes, etc.), locations of static objects, locations of intersections, road shape information, and/or the like. In some embodiments, the map information 412 may be determined with respect to the ego-vehicle 1100 such that, during perspective shifting, the change in orientation and location with respect to the map information is accomplished more efficiently. The map information 412 may be represented by an image (e.g., a rasterized image) representative of the lane locations, static object locations, etc. In some embodiments, each instance of the map information 412 may include a single image and may correspond to a single time slice—e.g., an instance may capture the driving surface structure (e.g., relative to the vehicle 1100) at the time slice. The DNN 416 may take as input one or more instances of the map information 412, such that DNN 416 may compute the outputs 418 using one or more instances of the map information 412 that correspond to the road structure information over various time slices (e.g., over a period of time). In some non-limiting embodiments, for each time slice within a period of time, a same map information 412 may be used (e.g., a same instance of the map information 412 may be used for every two time slices, every three time slices, etc., and then may be updated at a same interval). In other embodiments, the map information 412 may be updated at each time slice.

As an example, various inputs 408 corresponding to a time slice at a time, T₁, may include map information 412. As such, the map information 412 may include lane lines, line types, road shape and/or structure, and/or other features. Similarly, for a time slice at a time, T₂, the road structure may be represented. As a non-limiting example, the map information 412 may be oriented with respect to an ego-actor—which may be the centrally located actor—such that the DNN 416 may be conditioned on the ego-actor.

The wait conditions 414 may include locations of wait condition elements such as, without limitation, stop lights, yield signs, stop signs, construction, cross-walks, and/or other wait conditions, as well as locations of intersections defined or otherwise conducted using any of the wait condition elements listed above. In some embodiments, the wait conditions 414 may be included in the map information 412, while in other embodiments, the wait conditions 414 may represent a separate input channel to the DNN 416. In some embodiments, the wait conditions 414, similar to the past location 410 and/or the map information 412, may be determined with respect to the ego-vehicle 1100 such that, during perspective shifting, the change in orientation and location with respect to the wait conditions 414 is accomplished more efficiently. The wait conditions 414 may be represented by an image (e.g., a rasterized image) representative of the locations and/or types of wait conditions in the environment. In some embodiments, each instance of the wait conditions 414 may include a single image and may correspond to a single time slice—e.g., an instance may capture the wait conditions (e.g., relative to the vehicle 1100) at the time slice. The DNN 416 may take as input one or more instances of the wait conditions 414, such that the DNN 416 may compute the outputs 418 using one or more instances of the wait conditions that correspond to the wait condition locations and/or types over various time slices (e.g., over a period of time). In some non-limiting embodiments, for each time slice within a period of time, a same wait conditions 414 may be used (e.g., a same instance of the wait conditions 414 may be used for every two time slices, every three time slices, etc., and then may be updated at a same interval). In other embodiments, the wait conditions 414 may be updated at each time slice. As an example, various inputs 408 corresponding to a time slice at a time, T₁, may include wait conditions 414. As such, the wait conditions 414 may include stop signs, stop lights, yield signs, emergency vehicle entry locations, and/or other wait condition types. During training of the policy MLM 106 and/or the value function MLM 108, as in FIG. 1A, the simulation data 102 may represent any combination of the input(s) 408 (e.g., as encoded in or using the world state 118).

The inputs 408—e.g., after perspective shifting and/or rasterization—may be applied to the DNN 416 as input tensors. For example, each respective input—e.g., the map information 412, the past locations 410, the wait conditions 414, other input types, etc.—may each be applied as a separate input tensor to a channel(s) of the DNN 416. As described herein, in some embodiments, each input type may be associated with an individual input tensor and/or input channel. In other embodiments, two or more of the input types (e.g., the wait conditions 414 and the map information 412) may be combined to form a single input tensor for a single input channel to the DNN 416.

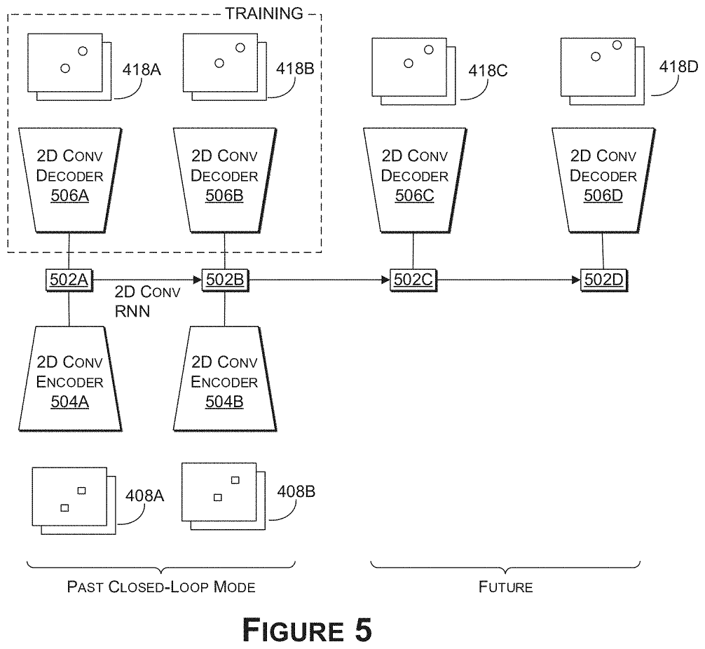

In some embodiments, the DNN 416 may include a temporal and/or spatial DNN such that the DNN 416 analyzes, at each instance, information corresponding to more than one time slice (e.g., a period of time) and/or analyzed, at each instance, information corresponding to more than one spatial location of actors. As such, the DNN 416 may learn to predict future trajectories—or information representative thereof—by monitoring and factoring in past locations of actors, road structures, wait conditions, and/or other information over a plurality of time slices. In some embodiments, the DNN 416 may include a recurrent neural network (RNN). For a non-limiting example, and as described in more detail below with respect to FIG. 5, the DNN 416 may include an encoder-decoder.

Although examples are described herein with respect to using neural networks, and specifically RNNs, as the DNN 416, this is not intended to be limiting. For example, and without limitation, the DNN 416 described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks, and/or other types of machine learning models. Examples of neural networks include auto-encoders, convolutional, recurrent, perceptrons, Long/Short Term Memory (LSTM), Hopfield, Boltzmann, deep belief, deconvolutional, generative adversarial, liquid state machine, graphical neural networks (GNNs), such as a GNN having one or more inputs including a map and one or more past trajectories), convolution neural networks (e.g., where past time slices may be represented by different tensor channels), etc.

Now with reference to FIG. 5, FIG. 5 depicts an example deep neural network (DNN) architecture suitable for implementation in at least one embodiment of the process of FIG. 4, in accordance with some embodiments of the present disclosure. The DNN 416 includes a plurality of encoder-decoder stacks that may each include a 2D convolutional encoder 504 (e.g., 504A-504B), a 2D convolutional decoder 506 (e.g., 506A-506D), and/or a 2D convolutional RNN 502 (e.g., 502A-502D). In one or more embodiments, the 2D convolutional encoder 504 may correspond to the encoder 304 in FIG. 3. Similarly, the 2D convolutional decoder 506 may correspond to the decoder 306A and/or 306B in FIG. 3.

The DNN 415 may be configured to receive any number of time slices worth of past information and predict any number of time slices worth of future information, depending on the embodiments. For example, the DNN 415 may generate a trajectory that includes information from the past two seconds and two seconds into the future—e.g., where a trajectory point is output every second, every half second, four times a second, eight times a second, and so on. For example, the inputs 408 may include a tensor(s) corresponding to past and/or predicted future locations of actors, a tensor(s) corresponding to wait conditions 414, a tensor(s) corresponding to map information 412, etc. The outputs 418 may include a tensor(s) corresponding to a confidence field (e.g., indicated by the gradients shown for the outputs 204 in FIG. 2), a tensor(s) corresponding to a vector field(s), etc. In some embodiments, because the inputs 408 in the closed-loop mode may be based on actual or simulated (e.g., ground truth) locations of one or more actors in the environment, the outputs 418 in the closed-loop mode may be more precise—e.g., may include a smaller area of potential locations for the actors which may be closer to a 1:1 correspondence between the input 408 and the output 418. In addition, because the inputs 408 in the open-loop mode may be based on future predictions or simulators of locations of one or more of the actors, the outputs 418 in the open-loop mode may be less precise—e.g., may include a larger area of potential locations for the actors.

The DNN 416 may include a past closed-loop mode and a future open-loop mode. In some embodiments, the past closed-loop mode may take as inputs 408 actual real-world or simulated past location(s) 110 of actors in the environment (in addition to other inputs 408, such as the map information 412, the wait conditions 414, etc.) in order to generate the outputs 418—e.g., as indicated by square boxes on the inputs 408A and 408B.

Referring again to FIG. 4, the outputs 418 of the DNN 416 may include confidence field(s) 420, vector field(s) 422, and/or other output types. The combination of the confidence field(s) 420 and the vector field(s) 422 may be used by a post-processor 424—described in more detail herein—to determine a full trajectory of one or more actors in the environment, which may include one or more past trajectory points or locations and/or one or more future trajectory points or locations. In some non-limiting embodiments, the confidence field(s) 420 and the vector field(s) 422 for a time slice may correspond to a same region of the environment (e.g., a same area) and thus may be of a same spatial dimension.

The confidence field(s) 420 may include, for each time slice (e.g., past, present, and/or future), a confidence field or map that represents confidences of where actors are located. The confidence field 420 may be represented by a H×W matrix, where each element (e.g., pixel or point) is representative of a confidence score. For example, each pixel or point in the confidence field 420 or map may have an associated confidence that an actor is present. As such, and especially for future predictions, the confidences field(s) 420 may appear more similar to the illustration of FIG. 2. For example, the visualization 200 of FIG. 2 may represent for the outputs 204 a plurality of confidence fields corresponding to a plurality of time slices overlaid on one another.

The vector field(s) 422 may include, for each time slice (e.g., past, present, and/or future), a vector field 422 or map that represents vectors (e.g., displacement vectors) corresponding to predictions of where an actor at the location of the vector was at the prior time slice. The vector field 422 may include an H×W matrix where each element (e.g., pixel or point) represents a 2D (or 3D, in embodiments) vector corresponding to a displacement from a current vector location to a point (e.g., a center point) of a same object or actor in a previous time slice (or time step). Each vector may be represented by, in some non-limiting embodiments, a direction and magnitude, a distance (e.g., a pixel distance) along the 2D or 3D space, and/or another representation. For example, each pixel or point in the vector field 422 or map for a time, Tₙ, may have an associated vector that represents where an actor—if an actor is present at the pixel or point—is predicted to be located at a prior time, Tₙ₋₁ (although, in embodiments, the DNN 416 may be trained to compute the vector fields 422 that correspond to a future time, Tₙ₊₁, for example).

The post-processor 424 may use the confidence field(s) 420 and the vector field(s) 422 to determine trajectories for any of the various actors in the environment. For example, the confidence field 420 corresponding to a last future time slice (e.g., Tₙ) of the outputs 418 may be analyzed by the post-processor 424 to determine locations of actors, and the corresponding vectors from the vector field 422 at the same time slice may be leveraged to determine predicted locations of the actors in a confidence field 420 from a preceding time slice (e.g., Tₙ₋₁). The confidence field 420 from the preceding time slice may then be used to determine the locations of the actors at that time slice (e.g., Tₙ₋₁), and then the vector field 422 from that time slice may be used to determine predicted locations of the actors in a confidence field 420 from a preceding time slice (e.g., Tₙ₋₂), and so on, until a current time is reached. A trajectory generator 426 may then append these future predictions to the past trajectory of the actors as determined from actual detections of the actors to generate a final trajectory. In some embodiments, the past trajectory may also be generated using a similar process as for the future trajectories, where the confidence fields 420 are used to determine locations at a time slice and the vector fields 422 are used to determine locations at prior time slices.

For a confidence field 420 corresponding to a time slice (e.g., as indicated by a time stamp, for example), the location of the actors may be determined using any number of different methods such as, without limitation, clustering-inclusive processes (e.g., non-maxima suppression, density-based spatial clustering of applications with noise (DBSCAN), etc.) and/or clustering-free processes. For example, where clustering is used, a confidence threshold may be applied to remove noisy points. In such examples, the confidence threshold may be, without limitation, 0.7, 0.8, 0.85, 0.9, etc. Once the noisy points are filtered out, the remaining points may have a clustering algorithm applied to them such that points that are within a threshold distance to one another may be determined to be associated with a single actor. In some embodiments, once the clusters are determined, one or more of the vectors from the vector field 422 of the same time slice that correspond to the same points may be used to find a location of a corresponding actor (or cluster representative thereof) in a preceding time slice. In other embodiments, once the clusters are determined, a centroid of each cluster may be determined, and a bounding shape of predetermined size (e.g., same size for all clusters, different size for clusters corresponding to different actor types—e.g., first size bounding shape for cars, second size bounding shape for pedestrians, and so on) may be centered at the centroid (e.g., a centroid of a bounding shape centered on the centroid of the cluster). The bounding shape may then be used as a mask for the vector field 422 of the same time slice to determine which vectors to use for finding a location of a corresponding actor (or cluster or bounding shape representative thereof) in a preceding time slice. These processes may be completed for each time slice until a full trajectory through each time slice is determined. In examples where another actor (or cluster or bounding shape representative thereof) is not located at the prior time slice using the vector field 422, the trajectory may be shortened, may be discarded (e.g., may be noise, a bug, etc.), and/or may be estimated based on past temporal information.

As another example, where clustering is not used, another algorithm or method may be implemented to determine the locations of actors. For example, a weighted averaging approach may be used where the confidence field(s) 420 and the vector field(s) 422 may be processed for each actor in a single pass—having the inherent compute benefit of fast processing times regardless of the number of actors. In such an algorithm, for each actor, a, a most probable next position may be the average of all positions whose predecessor vector points to a, weighted by the confidence field(s) 420 values at those positions. The weighted averages may be computed for all actors at once using auxiliary numerator and denominator storage—both initialized to zero. For each position, pos, in the output of the DNN 416, the predecessor, pred=predecessor[pos] and the occupancy, o=occupancy[pos]. Then add o*pos to numerator[pred], and add o to denominator[pred]. The next position for each actor, a, may be determined by numerator[a.position]/denominator[a.position]. The numerator stores the weighted sum of all positions whose predecessor vector points to a, and the denominator stores the sum of their weights, so the result is a weighted average. Since the operation to apply for each position is largely independent, these steps may be performed in parallel (e.g., using a graphics processing unit (GPU) across multiple threads in parallel).

As another example, for each actor, a, the confidence field 420 for a given time slice may be filtered to include pixels or points whose predecessor vector points to actor, a. The (soft) argmax function may be applied to the remaining points to determine a “center of mass” of the points. Specifically, the result may be the occupancy-weighted sum of all of the positions whose predecessor points to a. This may be determined to be the most likely future position for a. This process may be repeated for each other actor. In some embodiments, a separate pass may be executed over the same confidence field 420 for each actor, and this may be repeated at each time slice. As a result, the overall runtime of the system may be greater than desired for real-time or near real-time deployment. To avoid this, and to perform per-actor operations for all actors jointly, two partial sums may be stored. A first sum of weights for a shape H×W, according to equation (1), below:

$$sum\_weights [ y , x ] = {Σ}_{i , j ∈ H , W} \{ \begin{matrix}occupancy [ i , j ] & if predecessor [ i , j ] = ( y , x ) \\ 0 & otherwise \end{matrix} \qquad ( 1 )$$

and a second sum of weights for a shape H×W×2, according to equation (2) below:

$$sum\_weighted \_coords [ y , x , : ] = {Σ}_{i , j ∈ H , W} \{ \begin{matrix}( i , j \cdot occupancy [ i , j ] & if predecessor [ i , j ] = ( y , x ) \\ 0 & otherwise \end{matrix} \qquad ( 2 )$$

Then, to find the most likely successor for actor, a, equation (3) may be used

sum_weighted_coords[a.bbox.sum( )/sum_weights[a.bbox].sum( ) (3)

which may represent an occupancy-weighted average of all next-frame positions whose predecessor points to actor a (or a bounding box corresponding thereto).

In some examples, because the occupancy scores (e.g., from the confidence fields 420) are not probabilities, to avoid over-spreading trajectories, a sharpening operation may be performed. For example, a sharpening operation may be applied to the confidence fields 420 to assign higher weights to higher confidence scored points before computing the weighted average. In a non-limiting embodiments, the sharpening may be hard-coded with a sharpening strength of 40, as represented in equation (4), below:

sharpen(x)=e^{40·x-40} (4)

However, the sharpening function may also be learned or trained in some embodiments.

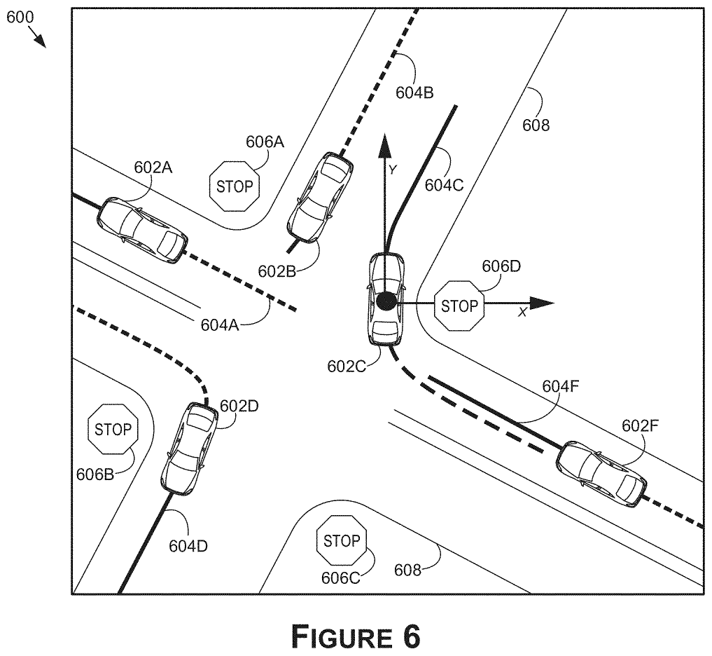

As another example, and with respect to FIG. 6, FIG. 6 depicts a visual representation of actors, associated trajectories, wait conditions, and a road structure, in accordance with some embodiments of the present disclosure. Visualization 600 may represent information passed to the drive stack 428 of the vehicle 1100 after the process 400 has been executed. For example, the visualization 600 may include an abstracted representation of a combination of inputs and outputs of the DNN 416 (e.g., after post-processing). For example, road structure or map information from the HD map 404 may be used to determine road boundaries 418, the wait conditions 414 may be used to determine stop signs 606A-606D are present and their locations, and trajectories 604A-604F for each of the actors 602A-602F, respectively, may be determined based on the outputs of the post-processor 424. In addition, as described herein, the representation may be ego-centered such that the visualization 600 is centered from a perspective of an ego-vehicle (e.g., actor 612C). The dashed lines of the trajectories 604 may represent past known or tracked locations of the actors 602 and the solid lines may represent predicted future locations of the actors 602. The locations of the actors 602 in the representation may represent the locations of the actors at the current time.

Referring again to FIG. 4, the outputs of the trajectory generator 426 may be transmitted or applied to the drive stack 428 of the vehicle 1100. For example, once the trajectories have been computed—and converted from 2D image-space coordinates to 3D world-space coordinates, in embodiments—the trajectories may be used by the autonomous vehicle 1100 in performing one or more operations (e.g., obstacle avoidance, lane keeping, lane changing, path planning, mapping, etc.). More specifically, the trajectories may be used by the drive stack 428 of the autonomous vehicle 1100, such as an autonomous machine software stack executing on one or more components of the vehicle 1100 (e.g., the SoC(s) 1104, the CPU(s) 1118, the GPU(s) 1120, etc.). For example, the vehicle 1100 may use this information (e.g., future locations of one or more actors in the environment) to navigate, plan, or otherwise perform one or more operations (e.g., obstacle avoidance, lane keeping, lane changing, path planning, merging, splitting, etc.) within the environment.

In some embodiments, the trajectories may be used by one or more layers of an autonomous machine software stack 428 (alternatively referred to herein as the “drive stack 428”). The drive stack 428 may include a sensor manager (not shown), perception component(s) (e.g., corresponding to a perception layer of the drive stack 428), a world model manager, planning component(s) (e.g., corresponding to a planning layer of the drive stack 428 and/or the planning manager 154), control component(s) (e.g., corresponding to a control layer of the drive stack 428 and/or the controller 156), obstacle avoidance component(s) (e.g., corresponding to an obstacle or collision avoidance layer of the drive stack 428), actuation component(s) (e.g., corresponding to an actuation layer of the drive stack 428), and/or other components corresponding to additional and/or alternative layers of the drive stack 428. The process 400 may, in some examples, be executed by the perception component(s), which may feed outputs from one or more layers of the drive stack 428 to the world model manager, as described in more detail herein.

The sensor manager may manage and/or abstract the sensor data 402 from the sensors of the vehicle 1100. For example, and with reference to FIG. 11C, the sensor data 402 may be generated (e.g., perpetually, at intervals, based on certain conditions) by RADAR sensor(s) 1160. The sensor manager may receive the sensor data 402 from the sensors in different formats (e.g., sensors of the same type may output sensor data in different formats), and may be configured to convert the different formats to a uniform format (e.g., for each sensor of the same type). As a result, other components, features, and/or functionality of the autonomous vehicle 1100 may use the uniform format, thereby simplifying processing of the sensor data 402. In some examples, the sensor manager may use a uniform format to apply a control parameter or instruction back to the sensors of the vehicle 1100, such as to set frame rates or to perform gain control. The sensor manager may also update sensor packets or communications corresponding to the sensor data with timestamps to help inform processing of the sensor data by various components, features, and functionality of an autonomous vehicle control system.

A world model manager may be used to generate, update, and/or define a world model. The world model manager may use information generated by and received from the perception component(s) of the drive stack 428 (e.g., the past and predicted locations of detected actors). During training, the simulator 116 may serve as the world model manager.

The perception component(s) may include an obstacle perceiver, a path perceiver, a wait perceiver, a map perceiver, and/or other perception component(s). For example, the world model (e.g., corresponding to the world state 118) may be defined, at least in part, based on affordances for obstacles, paths, and wait conditions that can be perceived in real-time or near real-time by the obstacle perceiver, the path perceiver, the wait perceiver, and/or the map perceiver. The world model manager may continually update the world model based on newly generated and/or received inputs (e.g., data) from the obstacle perceiver, the path perceiver, the wait perceiver, the map perceiver, and/or other components of the autonomous vehicle control system.

The world model may be used to help inform planning component(s), control component(s), obstacle avoidance component(s), and/or actuation component(s) of the drive stack 428. The obstacle perceiver may perform obstacle perception that may be based on where the vehicle 1100 is allowed to drive or is capable of driving (e.g., based on the location of the drivable paths defined by avoiding detected obstacles), and how fast the vehicle 1100 can drive without colliding with an obstacle (e.g., an object, such as a structure, entity, vehicle, etc.) that is sensed by the sensors of the vehicle 1100.

The path perceiver may perform path perception, such as by perceiving nominal paths that are available in a particular situation. In some examples, the path perceiver may further consider (e.g., account for) lane changes for path perception. A lane graph (e.g., generated using, at least in part, the HD map 404) may represent the path or paths available to the vehicle 1100, and may be as simple as a single path on a highway on-ramp. In some examples, the lane graph may include paths to a desired lane and/or may indicate available changes down the highway (or other road type), or may include nearby lanes, lane changes, forks, turns, cloverleaf interchanges, merges, and/or other information.

The wait perceiver may be responsible to determining constraints on the vehicle 1100 as a result of rules, conventions, and/or practical considerations. For example, the rules, conventions, and/or practical considerations may be in relation to traffic lights, multi-way stops, yields, merges, toll booths, gates, police or other emergency personnel, road workers, stopped buses or other vehicles, one-way bridge arbitrations, ferry entrances, etc. Thus, the wait perceiver may be leveraged to identify potential obstacles and implement one or more controls (e.g., slowing down, coming to a stop, etc.) that may not have been possible relying solely on the obstacle perceiver.

The map perceiver may include a mechanism by which behaviors are discerned, and in some examples, to determine specific examples of what conventions are applied at a particular locale. For example, the map perceiver may determine, from data representing prior drives or trips, that at a certain intersection there are no U-turns between certain hours, that an electronic sign showing directionality of lane changes depending on the time of day, that two traffic lights in close proximity (e.g., barely offset from one another) are associated with different roads, that in Rhode Island, the first car waiting to make a left turn at traffic light breaks the law by turning before oncoming traffic when the light turns green, and/or other information. The map perceiver may inform the vehicle 1100 of static or stationary infrastructure objects and obstacles. The map perceiver may also generate information for the wait perceiver and/or the path perceiver, for example, such as to determine which light at an intersection has to be green for the vehicle 1100 to take a particular path.

In some examples, information from the map perceiver may be sent, transmitted, and/or provided to server(s) (e.g., to a map manager of server(s) 1178 of FIG. 11D), and information from the server(s) may be sent, transmitted, and/or provided to the map perceiver and/or a localization manager of the vehicle 1100. The map manager may include a cloud mapping application that is remotely located from the vehicle 1100 and accessible by the vehicle 1100 over one or more network(s). For example, the map perceiver and/or the localization manager of the vehicle 1100 may communicate with the map manager and/or one or more other components or features of the server(s) to inform the map perceiver and/or the localization manager of past and present drives or trips of the vehicle 1100, as well as past and present drives or trips of other vehicles. The map manager may provide mapping outputs (e.g., map data) that may be localized by the localization manager based on a particular location of the vehicle 1100, and the localized mapping outputs may be used by the world model manager to generate and/or update the world model.

The planning component(s) may include the route planner 150, the lane planner 152, a behavior planner, and a behavior selector, among other components, features, and/or functionality. The behavior planner may determine the feasibility of basic behaviors of the vehicle 1100, such as staying in the lane or changing lanes left or right, so that the feasible behaviors may be matched up with the most desired behaviors output from the lane planner. For example, if the desired behavior is determined to not be safe and/or available, a default behavior may be selected instead (e.g., default behavior may be to stay in lane when desired behavior or changing lanes is not safe).

The control component(s) may follow a trajectory or path (lateral and longitudinal) that has been received from the behavior selector of the planning component(s) as closely as possible and within the capabilities of the vehicle 1100. The control component(s) may use tight feedback to handle unplanned events or behaviors that are not modeled and/or anything that causes discrepancies from the ideal (e.g., unexpected delay). In some examples, the control component(s) may use a forward prediction model that takes control as an input variable, and produces predictions that may be compared with the desired state (e.g., compared with the desired lateral and longitudinal path requested by the planning component(s)). In this manner, the control(s) that minimize discrepancy may be determined.

The obstacle avoidance component(s) may aid the autonomous vehicle 1100 in avoiding collisions with objects (e.g., moving or stationary objects). The obstacle avoidance component(s) may include a computational mechanism at a “primal level” of obstacle avoidance, and may act as a “survival brain” or “reptile brain” for the vehicle 1100. In some examples, the obstacle avoidance component(s) may be used independently of components, features, and/or functionality of the vehicle 1100 that is required to obey traffic rules and drive courteously. In such examples, the obstacle avoidance component(s) may ignore traffic laws, rules of the road, and courteous driving norms in order to ensure that collisions do not occur between the vehicle 1100 and any objects. As such, the obstacle avoidance layer may be a separate layer from the rules of the road layer, and the obstacle avoidance layer may ensure that the vehicle 1100 is only performing safe actions from an obstacle avoidance standpoint. The rules of the road layer, on the other hand, may ensure that vehicle obeys traffic laws and conventions, and observes lawful and conventional right of way (as described herein).

In some examples, the drivable paths and/or object detections may be used by the obstacle avoidance component(s) in determining controls or actions to take. For example, the drivable paths may provide an indication to the obstacle avoidance component(s) of where the vehicle 1100 may maneuver without striking any objects, structures, and/or the like, or at least where no static structures may exist.

In non-limiting embodiments, the obstacle avoidance component(s) may be implemented as a separate, discrete feature of the vehicle 1100. For example, the obstacle avoidance component(s) may operate separately (e.g., in parallel with, prior to, and/or after) the planning layer, the control layer, the actuation layer, and/or other layers of the drive stack 428.

As such, the vehicle 1100 may use this information (e.g., as the edges, or rails of the paths) to navigate, plan, or otherwise perform one or more operations (e.g., lane keeping, lane changing, path planning, merging, splitting, etc.) within the environment.

Now referring to FIG. 7, FIG. 7 illustrates an example of extending a predicted path using a kinetic motion algorithm (also known as a classical mechanical motion algorithm), in accordance with some embodiments of the present disclosure. As discussed herein, locations (e.g., trajectories) for the one or more actors may be predicted and/or determined. In at least one embodiment, at least a first location for one or more actors may correspond to a prediction made using one or more of the prediction MLM 104, the policy MLM 106, and/or the value function MLM 108, as described herein. In some embodiments, the first location may be extended to at least a second location using the kinetic motion algorithm which may, for example, assume a steady trajectory out to the second location to generate an extended trajectory. In at least one embodiment, the value function described herein may be based on the extended trajectory for one or more actors.

As shown in FIG. 7, a vehicle 702 (with locations indicated by 702A-D) may traverse a trajectory 704. When predicting trajectories that are followed to eventually result in the trajectory 704, a classical mechanical motion algorithm may be used to calculate a corresponding hold or extended trajectory 706A-D for each predicted trajectory. For example, at 702A, the vehicle 702 includes a predicted trajectory that continues along a hold trajectory 706A. The hold trajectory 706A may be calculated based at least in part on actor attributes of the vehicle 702 at or near the end of the predicted trajectory (e.g., velocity, acceleration, pose, etc.). The hold trajectory 706A may thus extend the predicted trajectory (e.g., corresponding to the output 204 of FIG. 2) to a further time interval, which may be used by various planning and control components described herein. While the classical mechanical motion algorithm may maintain a direction and/or velocity of the vehicle 702 is computing the extended portion of a trajectory, some examples may include varying the direction and/or velocity or maintain one or more other properties of the predicted trajectory and/or actor attributes or state (e.g., an angle of curvature may be maintained).

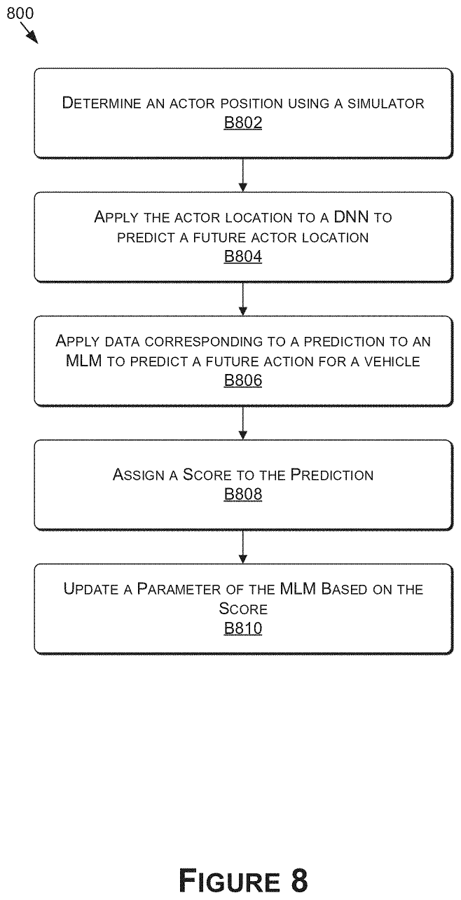

Now referring to FIGS. 8-10, each block of methods 800, 900, and 100, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 800, 900, and 1000 are described, by way of example, with respect to the model training system 100 of FIG. 1A. However, these methods may additionally or alternatively be executed by any one system, or any combination of systems, including, but not limited to, those described herein. For example, the methods may be performed by a system comprising one or more processing units, and one or more memory units storing instructions that, when executed by the one or more processing units, cause the one or more processing units to execute operations.

FIG. 8 is a flow diagram showing a method 800 for training a machine learning model to predict actor movements using actor positions predicted using a DNN, in accordance with some embodiments of the present disclosure. The method 800, at block B802, includes determining an actor position using a simulator. In one or more embodiments, a position of an actor may include, without limitation, one or more of the actor's location, pose, orientation, size, height, yaw, pitch, or roll, etc.) For example, the training engine 112 may determine, using a simulation corresponding to the world state 118, a first at least one position of one or more actors based at least on a first state of an environment. The one or more actors may include the vehicle and/or at least one other vehicle.

The method 800, at block B804, includes applying the actor position to a DNN trained to predict a future actor position. For example, the training engine 112 may apply the simulation data 102 to the prediction MLM 104 trained to generate, from the first at least one position of the one or more actors, predictions of a second at least one position of the one or more actors. In embodiments, the prediction MLM 104 was trained using imitation learning based upon real-world data.

The method 800, at block B806, includes applying data corresponding to a prediction of the DNN to an MLM to predict a future action for a vehicle. For example, the training engine 1112 may applying second data corresponding to the predictions to the policy MLM 106 to generate, using the at least one MLM, a prediction corresponding to one or more actions for a vehicle.

The method 800, at block B808, includes assigning a score to the prediction. For example, the training engine 112 may assign one or more scores to the prediction using a value function based at least on a second state of the environment that corresponds to the predictions.

The method 800, at block B810, includes updating a parameter of the MLM based on the score. For example, the training engine 112 may update one or more parameters of the policy MLM 106 based at least on the one or more scores (e.g., the decoder 306A and/or 306B).

The method 800 may further include predicting one or more positions of the one or more actors using the DNN, wherein the determining the first at least one position of one or more actors includes adjusting at least one of the one or more positions based on modeling behavior of an actor to generate the first at least one position. The second at least one position of the one or more actors may correspond to a trajectory of an actor and the method includes extending the trajectory using a classical mechanical motion algorithm to generate an extended trajectory, wherein the one or more scores correspond to the extended trajectory. The method 800 may further include determining, from the second state of the environment, a collision of the vehicle in the environment and computing the one or more scores based at least on the determining of the collision.

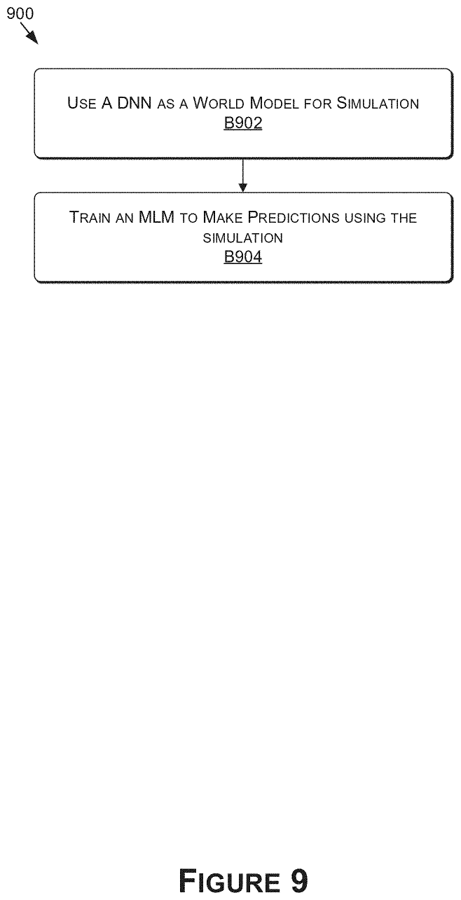

FIG. 9 is a flow diagram showing a method 900 for training a machine learning model to make predictions using a DNN as a world model, in accordance with some embodiments of the present disclosure. The method 900, at block B902, includes using a DNN as a world model for a simulation. For example, the training engine 112 may use the prediction MLM 104 as a world model for a simulation.

The method 900, at block B904, includes training an MLM to make predictions using the simulation. For example, the training engine 112 may apply reinforcement learning to train at least one MLM to generate a prediction of one or more actions for a machine using the simulation. A latent space of the DNN may be decoded into a state of the world model for the simulation to apply the reinforcement learning to train the at least one MLM using the simulation. The DNN may have been trained using imitation learning of real-world data, and may be used to train the at least one MLM to generate a prediction of a trajectory for a vehicle. One or more value function neural networks may be trained to generate a prediction of one or more scores of a value function of the RL.

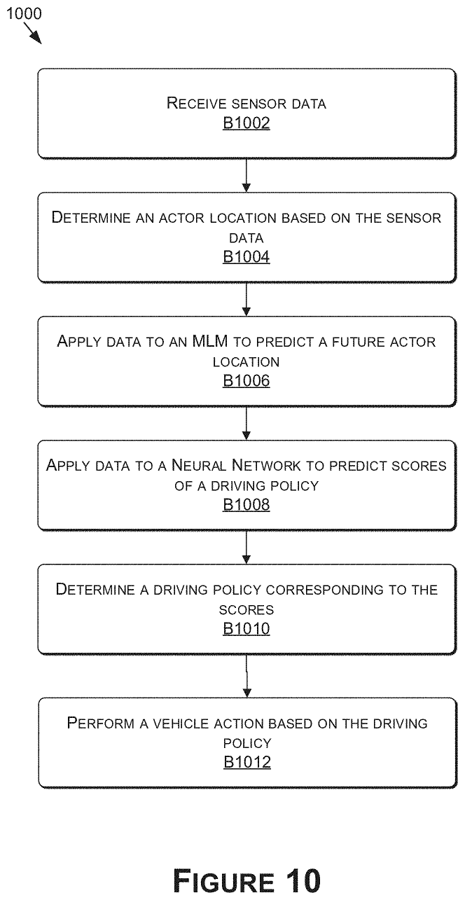

FIG. 10 is a flow diagram showing a method 1000 for controlling an autonomous vehicle based upon predictions simulated using a MLM, in accordance with some embodiments of the present disclosure. The method 1000, at block B1002, includes receiving sensor data. This may include receiving sensor data generated by one or more sensors of a vehicle within an environment.

The method 1000, at block B1004, includes determining an actor position based on the sensor data. This may include determining, based at least in part on the sensor data, a first at least one position of one or more actors.

The method 1000, at block B1006, includes applying data to an MLM to predict future actor positions. This may include applying first data to a deep neural network (DNN) trained to generate, from the first at least one position of the one or more actors, predictions of a second at least one position of the one or more actors.

The method 1000, at block B1008, includes applying data to a neural network to predict scores of a driving policy. This may include applying second data corresponding to the predictions to a neural network (e.g., the value function MLM 108) to generate, using the neural network, predictions of one or more scores of a value function, the one or more scores corresponding to one or more driving policies. The value function may include a state value function. States of the value function may correspond to times and locations of the second at least one position in a latent space of the MLM. In embodiments, the second data encodes one or more goals for the one or more driving policies and the one or more scores correspond to the one or more goals. In embodiments, the neural network decodes at least a portion of the latent space of the DNN to generate the predictions of the one or more scores.

The method 1000, at block B1010, includes determining a driving policy that corresponds to the one or more scores. The method 100, at block B1012 includes performing a vehicle action based on the driving policy. This may include transmitting data causing a vehicle to perform one or more actions based on the one or more driving policies.

### Example Autonomous Vehicle

FIG. 11A is an illustration of an example autonomous vehicle 1100, in accordance with some embodiments of the present disclosure. The autonomous vehicle 1100 (alternatively referred to herein as the “vehicle 1100”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, a vehicle coupled to a trailer, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1100 may be capable of functionality in accordance with one or more of Level 3-Level 5 of the autonomous driving levels. The vehicle 1100 may be capable of functionality in accordance with one or more of Level 1-Level 5 of the autonomous driving levels. For example, the vehicle 1100 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1100 or other machine, such as being fully autonomous, being highly autonomous, being conditionally autonomous, being partially autonomous, providing assistive autonomy, being semi-autonomous, being primarily autonomous, or other designation.

The vehicle 1100 may include components such as a chassis, a vehicle body, wheels (e.g., 2, 4, 6, 8, 18, etc.), tires, axles, and other components of a vehicle. The vehicle 1100 may include a propulsion system 1150, such as an internal combustion engine, hybrid electric power plant, an all-electric engine, and/or another propulsion system type. The propulsion system 1150 may be connected to a drive train of the vehicle 1100, which may include a transmission, to enable the propulsion of the vehicle 1100. The propulsion system 1150 may be controlled in response to receiving signals from the throttle/accelerator 1152.

A steering system 1154, which may include a steering wheel, may be used to steer the vehicle 1100 (e.g., along a desired path or route) when the propulsion system 1150 is operating (e.g., when the vehicle is in motion). The steering system 1154 may receive signals from a steering actuator 1156. The steering wheel may be optional for full automation (Level 5) functionality.

The brake sensor system 1146 may be used to operate the vehicle brakes in response to receiving signals from the brake actuators 1148 and/or brake sensors.

Controller(s) 1136, which may include one or more system on chips (SoCs) 1104 (FIG. 11C) and/or GPU(s), may provide signals (e.g., representative of commands) to one or more components and/or systems of the vehicle 1100. For example, the controller(s) may send signals to operate the vehicle brakes via one or more brake actuators 1148, to operate the steering system 1154 via one or more steering actuators 1156, to operate the propulsion system 1150 via one or more throttle/accelerators 1152. The controller(s) 1136 may include one or more onboard (e.g., integrated) computing devices (e.g., supercomputers) that process sensor signals, and output operation commands (e.g., signals representing commands) to enable autonomous driving and/or to assist a human driver in driving the vehicle 1100. The controller(s) 1136 may include a first controller 1136 for autonomous driving functions, a second controller 1136 for functional safety functions, a third controller 1136 for artificial intelligence functionality (e.g., computer vision), a fourth controller 1136 for infotainment functionality, a fifth controller 1136 for redundancy in emergency conditions, and/or other controllers. In some examples, a single controller 1136 may handle two or more of the above functionalities, two or more controllers 1136 may handle a single functionality, and/or any combination thereof.

The controller(s) 1136 may provide the signals for controlling one or more components and/or systems of the vehicle 1100 in response to sensor data received from one or more sensors (e.g., sensor inputs). The sensor data may be received from, for example and without limitation, global navigation satellite systems sensor(s) 1158 (e.g., Global Positioning System sensor(s)), RADAR sensor(s) 1160, ultrasonic sensor(s) 1162, LIDAR sensor(s) 1164, inertial measurement unit (IMU) sensor(s) 1166 (e.g., accelerometer(s), gyroscope(s), magnetic compass(es), magnetometer(s), etc.), microphone(s) 1196, stereo camera(s) 1168, wide-view camera(s) 1170 (e.g., fisheye cameras), infrared camera(s) 1172, surround camera(s) 1174 (e.g., 360 degree cameras), long-range and/or mid-range camera(s) 1198, speed sensor(s) 1144 (e.g., for measuring the speed of the vehicle 1100), vibration sensor(s) 1142, steering sensor(s) 1140, brake sensor(s) (e.g., as part of the brake sensor system 1146), and/or other sensor types.

One or more of the controller(s) 1136 may receive inputs (e.g., represented by input data) from an instrument cluster 1132 of the vehicle 1100 and provide outputs (e.g., represented by output data, display data, etc.) via a human-machine interface (HMI) display 1134, an audible annunciator, a loudspeaker, and/or via other components of the vehicle 1100. The outputs may include information such as vehicle velocity, speed, time, map data (e.g., the HD map 1122 of FIG. 11C), location data (e.g., the vehicle's 1100 location, such as on a map), direction, location of other vehicles (e.g., an occupancy grid), information about objects and status of objects as perceived by the controller(s) 1136, etc. For example, the HMI display 1134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1100 further includes a network interface 1124 which may use one or more wireless antenna(s) 1126 and/or modem(s) to communicate over one or more networks. For example, the network interface 1124 may be capable of communication over LTE, WCDMA, UMTS, GSM, CDMA2000, etc. The wireless antenna(s) 1126 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 11B is an example of camera locations and fields of view for the example autonomous vehicle 1100 of FIG. 11A, in accordance with some embodiments of the present disclosure. The cameras and respective fields of view are one example embodiment and are not intended to be limiting. For example, additional and/or alternative cameras may be included and/or the cameras may be located at different locations on the vehicle 1100.

The camera types for the cameras may include, but are not limited to, digital cameras that may be adapted for use with the components and/or systems of the vehicle 1100. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1100 (e.g., front-facing cameras) may be used for surround view, to help identify forward facing paths and obstacles, as well aid in, with the help of one or more controllers 1136 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 1170 that may be used to perceive objects coming into view from the periphery (e.g., pedestrians, crossing traffic or bicycles). Although only one wide-view camera is illustrated in FIG. 11B, there may any number of wide-view cameras 1170 on the vehicle 1100. In addition, long-range camera(s) 1198 (e.g., a long-view stereo camera pair) may be used for depth-based object detection, especially for objects for which a neural network has not yet been trained. The long-range camera(s) 1198 may also be used for object detection and classification, as well as basic object tracking.

One or more stereo cameras 1168 may also be included in a front-facing configuration. The stereo camera(s) 1168 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 1168 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1168 may be used in addition to, or alternatively from, those described herein.

Cameras with a field of view that include portions of the environment to the side of the vehicle 1100 (e.g., side-view cameras) may be used for surround view, providing information used to create and update the occupancy grid, as well as to generate side impact collision warnings. For example, surround camera(s) 1174 (e.g., four surround cameras 1174 as illustrated in FIG. 11B) may be positioned to on the vehicle 1100. The surround camera(s) 1174 may include wide-view camera(s) 1170, fisheye camera(s), 360 degree camera(s), and/or the like. Four example, four fisheye cameras may be positioned on the vehicle's front, rear, and sides. In an alternative arrangement, the vehicle may use three surround camera(s) 1174 (e.g., left, right, and rear), and may leverage one or more other camera(s) (e.g., a forward-facing camera) as a fourth surround view camera.

Cameras with a field of view that include portions of the environment to the rear of the vehicle 1100 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1198, stereo camera(s) 1168), infrared camera(s) 1172, etc.), as described herein.

FIG. 11C is a block diagram of an example system architecture for the example autonomous vehicle 1100 of FIG. 11A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1100 in FIG. 11C are illustrated as being connected via bus 1102. The bus 1102 may include a Controller Area Network (CAN) data interface (alternatively referred to herein as a “CAN bus”). A CAN may be a network inside the vehicle 1100 used to aid in control of various features and functionality of the vehicle 1100, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1102 is described herein as being a CAN bus, this is not intended to be limiting. For example, in addition to, or alternatively from, the CAN bus, FlexRay and/or Ethernet may be used. Additionally, although a single line is used to represent the bus 1102, this is not intended to be limiting. For example, there may be any number of busses 1102, which may include one or more CAN busses, one or more FlexRay busses, one or more Ethernet busses, and/or one or more other types of busses using a different protocol. In some examples, two or more busses 1102 may be used to perform different functions, and/or may be used for redundancy. For example, a first bus 1102 may be used for collision avoidance functionality and a second bus 1102 may be used for actuation control. In any example, each bus 1102 may communicate with any of the components of the vehicle 1100, and two or more busses 1102 may communicate with the same components. In some examples, each SoC 1104, each controller 1136, and/or each computer within the vehicle may have access to the same input data (e.g., inputs from sensors of the vehicle 1100), and may be connected to a common bus, such the CAN bus.

The vehicle 1100 may include one or more controller(s) 1136, such as those described herein with respect to FIG. 11A. The controller(s) 1136 may be used for a variety of functions. The controller(s) 1136 may be coupled to any of the various other components and systems of the vehicle 1100, and may be used for control of the vehicle 1100, artificial intelligence of the vehicle 1100, infotainment for the vehicle 1100, and/or the like.

The vehicle 1100 may include a system(s) on a chip (SoC) 1104. The SoC 1104 may include CPU(s) 1106, GPU(s) 1108, processor(s) 1110, cache(s) 1112, accelerator(s) 1114, data store(s) 1116, and/or other components and features not illustrated. The SoC(s) 1104 may be used to control the vehicle 1100 in a variety of platforms and systems. For example, the SoC(s) 1104 may be combined in a system (e.g., the system of the vehicle 1100) with an HD map 1122 which may obtain map refreshes and/or updates via a network interface 1124 from one or more servers (e.g., server(s) 1178 of FIG. 11D).

The CPU(s) 1106 may include a CPU cluster or CPU complex (alternatively referred to herein as a “CCPLEX”). The CPU(s) 1106 may include multiple cores and/or L2 caches. For example, in some embodiments, the CPU(s) 1106 may include eight cores in a coherent multi-processor configuration. In some embodiments, the CPU(s) 1106 may include four dual-core clusters where each cluster has a dedicated L2 cache (e.g., a 2 MB L2 cache). The CPU(s) 1106 (e.g., the CCPLEX) may be configured to support simultaneous cluster operation enabling any combination of the clusters of the CPU(s) 1106 to be active at any given time.

The CPU(s) 1106 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1106 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1108 may include an integrated GPU (alternatively referred to herein as an “iGPU”). The GPU(s) 1108 may be programmable and may be efficient for parallel workloads. The GPU(s) 1108, in some examples, may use an enhanced tensor instruction set. The GPU(s) 1108 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1108 may include at least eight streaming microprocessors. The GPU(s) 1108 may use compute application programming interface(s) (API(s)). In addition, the GPU(s) 1108 may use one or more parallel computing platforms and/or programming models (e.g., NVIDIA's CUDA).

The GPU(s) 1108 may be power-optimized for best performance in automotive and embedded use cases. For example, the GPU(s) 1108 may be fabricated on a Fin field-effect transistor (FinFET). However, this is not intended to be limiting and the GPU(s) 1108 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1108 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1108 to access the CPU(s) 1106 page tables directly. In such examples, when the GPU(s) 1108 memory management unit (MMU) experiences a miss, an address translation request may be transmitted to the CPU(s) 1106. In response, the CPU(s) 1106 may look in its page tables for the virtual-to-physical mapping for the address and transmits the translation back to the GPU(s) 1108. As such, unified memory technology may allow a single unified virtual address space for memory of both the CPU(s) 1106 and the GPU(s) 1108, thereby simplifying the GPU(s) 1108 programming and porting of applications to the GPU(s) 1108.

In addition, the GPU(s) 1108 may include an access counter that may keep track of the frequency of access of the GPU(s) 1108 to memory of other processors. The access counter may help ensure that memory pages are moved to the physical memory of the processor that is accessing the pages most frequently.

The SoC(s) 1104 may include any number of cache(s) 1112, including those described herein. For example, the cache(s) 1112 may include an L3 cache that is available to both the CPU(s) 1106 and the GPU(s) 1108 (e.g., that is connected both the CPU(s) 1106 and the GPU(s) 1108). The cache(s) 1112 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1104 may include an arithmetic logic unit(s) (ALU(s)) which may be leveraged in performing processing with respect to any of the variety of tasks or operations of the vehicle 1100—such as processing DNNs. In addition, the SoC(s) 1104 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1106 and/or GPU(s) 1108.

The SoC(s) 1104 may include one or more accelerators 1114 (e.g., hardware accelerators, software accelerators, or a combination thereof). For example, the SoC(s) 1104 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1108 and to off-load some of the tasks of the GPU(s) 1108 (e.g., to free up more cycles of the GPU(s) 1108 for performing other tasks). As an example, the accelerator(s) 1114 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1114 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1108, and by using an inference accelerator, for example, a designer may target either the DLA(s) or the GPU(s) 1108 for any function. For example, the designer may focus processing of CNNs and floating point operations on the DLA(s) and leave other functions to the GPU(s) 1108 and/or other accelerator(s) 1114.

The accelerator(s) 1114 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1106. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1114 (e.g., the hardware acceleration cluster) may include a computer vision network on-chip and SRAM, for providing a high-bandwidth, low latency SRAM for the accelerator(s) 1114. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1104 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1114 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1166 output that correlates with the vehicle 1100 orientation, distance, 3D location estimates of the object obtained from the neural network and/or other sensors (e.g., LIDAR sensor(s) 1164 or RADAR sensor(s) 1160), among others.

The SoC(s) 1104 may include data store(s) 1116 (e.g., memory). The data store(s) 1116 may be on-chip memory of the SoC(s) 1104, which may store neural networks to be executed on the GPU and/or the DLA. In some examples, the data store(s) 1116 may be large enough in capacity to store multiple instances of neural networks for redundancy and safety. The data store(s) 1112 may comprise L2 or L3 cache(s) 1112. Reference to the data store(s) 1116 may include reference to the memory associated with the PVA, DLA, and/or other accelerator(s) 1114, as described herein.

The SoC(s) 1104 may include one or more processor(s) 1110 (e.g., embedded processors). The processor(s) 1110 may include a boot and power management processor that may be a dedicated processor and subsystem to handle boot power and management functions and related security enforcement. The boot and power management processor may be a part of the SoC(s) 1104 boot sequence and may provide runtime power management services. The boot power and management processor may provide clock and voltage programming, assistance in system low power state transitions, management of SoC(s) 1104 thermals and temperature sensors, and/or management of the SoC(s) 1104 power states. Each temperature sensor may be implemented as a ring-oscillator whose output frequency is proportional to temperature, and the SoC(s) 1104 may use the ring-oscillators to detect temperatures of the CPU(s) 1106, GPU(s) 1108, and/or accelerator(s) 1114. If temperatures are determined to exceed a threshold, the boot and power management processor may enter a temperature fault routine and put the SoC(s) 1104 into a lower power state and/or put the vehicle 1100 into a chauffeur to safe stop mode (e.g., bring the vehicle 1100 to a safe stop).

The processor(s) 1110 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1110 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1110 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1110 may further include a real-time camera engine that may include a dedicated processor subsystem for handling real-time camera management.

The processor(s) 1110 may further include a high-dynamic range signal processor that may include an image signal processor that is a hardware engine that is part of the camera processing pipeline.

The processor(s) 1110 may include a video image compositor that may be a processing block (e.g., implemented on a microprocessor) that implements video post-processing functions needed by a video playback application to produce the final image for the player window. The video image compositor may perform lens distortion correction on wide-view camera(s) 1170, surround camera(s) 1174, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1108 is not required to continuously render new surfaces. Even when the GPU(s) 1108 is powered on and active doing 3D rendering, the video image compositor may be used to offload the GPU(s) 1108 to improve performance and responsiveness.

The SoC(s) 1104 may further include a mobile industry processor interface (MIPI) camera serial interface for receiving video and input from cameras, a high-speed interface, and/or a video input block that may be used for camera and related pixel input functions. The SoC(s) 1104 may further include an input/output controller(s) that may be controlled by software and may be used for receiving I/O signals that are uncommitted to a specific role.

The SoC(s) 1104 may further include a broad range of peripheral interfaces to enable communication with peripherals, audio codecs, power management, and/or other devices. The SoC(s) 1104 may be used to process data from cameras (e.g., connected over Gigabit Multimedia Serial Link and Ethernet), sensors (e.g., LIDAR sensor(s) 1164, RADAR sensor(s) 1160, etc. that may be connected over Ethernet), data from bus 1102 (e.g., speed of vehicle 1100, steering wheel position, etc.), data from GNSS sensor(s) 1158 (e.g., connected over Ethernet or CAN bus). The SoC(s) 1104 may further include dedicated high-performance mass storage controllers that may include their own DMA engines, and that may be used to free the CPU(s) 1106 from routine data management tasks.

The SoC(s) 1104 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1104 may be faster, more reliable, and even more energy-efficient and space-efficient than conventional systems. For example, the accelerator(s) 1114, when combined with the CPU(s) 1106, the GPU(s) 1108, and the data store(s) 1116, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1120) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1108.

In some examples, a CNN for facial recognition and vehicle owner identification may use data from camera sensors to identify the presence of an authorized driver and/or owner of the vehicle 1100. The always on sensor processing engine may be used to unlock the vehicle when the owner approaches the driver door and turn on the lights, and, in security mode, to disable the vehicle when the owner leaves the vehicle. In this way, the SoC(s) 1104 provide for security against theft and/or carjacking.

In another example, a CNN for emergency vehicle detection and identification may use data from microphones 1196 to detect and identify emergency vehicle sirens. In contrast to conventional systems, that use general classifiers to detect sirens and manually extract features, the SoC(s) 1104 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1158. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1162, until the emergency vehicle(s) passes.

The vehicle may include a CPU(s) 1118 (e.g., discrete CPU(s), or dCPU(s)), that may be coupled to the SoC(s) 1104 via a high-speed interconnect (e.g., PCIe). The CPU(s) 1118 may include an X86 processor, for example. The CPU(s) 1118 may be used to perform any of a variety of functions, including arbitrating potentially inconsistent results between ADAS sensors and the SoC(s) 1104, and/or monitoring the status and health of the controller(s) 1136 and/or infotainment SoC 1130, for example.

The vehicle 1100 may include a GPU(s) 1120 (e.g., discrete GPU(s), or dGPU(s)), that may be coupled to the SoC(s) 1104 via a high-speed interconnect (e.g., NVIDIA's NVLINK). The GPU(s) 1120 may provide additional artificial intelligence functionality, such as by executing redundant and/or different neural networks, and may be used to train and/or update neural networks based on input (e.g., sensor data) from sensors of the vehicle 1100.

The vehicle 1100 may further include the network interface 1124 which may include one or more wireless antennas 1126 (e.g., one or more wireless antennas for different communication protocols, such as a cellular antenna, a Bluetooth antenna, etc.). The network interface 1124 may be used to enable wireless connectivity over the Internet with the cloud (e.g., with the server(s) 1178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1100 information about vehicles in proximity to the vehicle 1100 (e.g., vehicles in front of, on the side of, and/or behind the vehicle 1100). This functionality may be part of a cooperative adaptive cruise control functionality of the vehicle 1100.

The network interface 1124 may include a SoC that provides modulation and demodulation functionality and enables the controller(s) 1136 to communicate over wireless networks. The network interface 1124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1100 may further include data store(s) 1128 which may include off-chip (e.g., off the SoC(s) 1104) storage. The data store(s) 1128 may include one or more storage elements including RAM, SRAM, DRAM, VRAM, Flash, hard disks, and/or other components and/or devices that may store at least one bit of data.

The vehicle 1100 may further include GNSS sensor(s) 1158. The GNSS sensor(s) 1158 (e.g., GPS, assisted GPS sensors, differential GPS (DGPS) sensors, etc.), to assist in mapping, perception, occupancy grid generation, and/or path planning functions. Any number of GNSS sensor(s) 1158 may be used, including, for example and without limitation, a GPS using a USB connector with an Ethernet to Serial (RS-232) bridge.

The vehicle 1100 may further include RADAR sensor(s) 1160. The RADAR sensor(s) 1160 may be used by the vehicle 1100 for long-range vehicle detection, even in darkness and/or severe weather conditions. RADAR functional safety levels may be ASIL B. The RADAR sensor(s) 1160 may use the CAN and/or the bus 1102 (e.g., to transmit data generated by the RADAR sensor(s) 1160) for control and to access object tracking data, with access to Ethernet to access raw data in some examples. A wide variety of RADAR sensor types may be used. For example, and without limitation, the RADAR sensor(s) 1160 may be suitable for front, rear, and side RADAR use. In some example, Pulse Doppler RADAR sensor(s) are used.

The RADAR sensor(s) 1160 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1160 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1100 surroundings at higher speeds with minimal interference from traffic in adjacent lanes. The other two antennae may expand the field of view, making it possible to quickly detect vehicles entering or leaving the vehicle's 1100 lane.

Mid-range RADAR systems may include, as an example, a range of up to 1160 m (front) or 80 m (rear), and a field of view of up to 42 degrees (front) or 1150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1100 may further include ultrasonic sensor(s) 1162. The ultrasonic sensor(s) 1162, which may be positioned at the front, back, and/or the sides of the vehicle 1100, may be used for park assist and/or to create and update an occupancy grid. A wide variety of ultrasonic sensor(s) 1162 may be used, and different ultrasonic sensor(s) 1162 may be used for different ranges of detection (e.g., 2.5 m, 4 m). The ultrasonic sensor(s) 1162 may operate at functional safety levels of ASIL B.

The vehicle 1100 may include LIDAR sensor(s) 1164. The LIDAR sensor(s) 1164 may be used for object and pedestrian detection, emergency braking, collision avoidance, and/or other functions. The LIDAR sensor(s) 1164 may be functional safety level ASIL B. In some examples, the vehicle 1100 may include multiple LIDAR sensors 1164 (e.g., two, four, six, etc.) that may use Ethernet (e.g., to provide data to a Gigabit Ethernet switch).

In some examples, the LIDAR sensor(s) 1164 may be capable of providing a list of objects and their distances for a 360-degree field of view. Commercially available LIDAR sensor(s) 1164 may have an advertised range of approximately 1100 m, with an accuracy of 2 cm-3 cm, and with support for a 1100 Mbps Ethernet connection, for example. In some examples, one or more non-protruding LIDAR sensors 1164 may be used. In such examples, the LIDAR sensor(s) 1164 may be implemented as a small device that may be embedded into the front, rear, sides, and/or corners of the vehicle 1100. The LIDAR sensor(s) 1164, in such examples, may provide up to a 120-degree horizontal and 35-degree vertical field-of-view, with a 200 m range even for low-reflectivity objects. Front-mounted LIDAR sensor(s) 1164 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1100. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1164 may be less susceptible to motion blur, vibration, and/or shock.

The vehicle may further include IMU sensor(s) 1166. The IMU sensor(s) 1166 may be located at a center of the rear axle of the vehicle 1100, in some examples. The IMU sensor(s) 1166 may include, for example and without limitation, an accelerometer(s), a magnetometer(s), a gyroscope(s), a magnetic compass(es), and/or other sensor types. In some examples, such as in six-axis applications, the IMU sensor(s) 1166 may include accelerometers and gyroscopes, while in nine-axis applications, the IMU sensor(s) 1166 may include accelerometers, gyroscopes, and magnetometers.

In some embodiments, the IMU sensor(s) 1166 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1166 may enable the vehicle 1100 to estimate heading without requiring input from a magnetic sensor by directly observing and correlating the changes in velocity from GPS to the IMU sensor(s) 1166. In some examples, the IMU sensor(s) 1166 and the GNSS sensor(s) 1158 may be combined in a single integrated unit.

The vehicle may include microphone(s) 1196 placed in and/or around the vehicle 1100. The microphone(s) 1196 may be used for emergency vehicle detection and identification, among other things.

The vehicle may further include any number of camera types, including stereo camera(s) 1168, wide-view camera(s) 1170, infrared camera(s) 1172, surround camera(s) 1174, long-range and/or mid-range camera(s) 1198, and/or other camera types. The cameras may be used to capture image data around an entire periphery of the vehicle 1100. The types of cameras used depends on the embodiments and requirements for the vehicle 1100, and any combination of camera types may be used to provide the necessary coverage around the vehicle 1100. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 11A and FIG. 11B.

The vehicle 1100 may further include vibration sensor(s) 1142. The vibration sensor(s) 1142 may measure vibrations of components of the vehicle, such as the axle(s). For example, changes in vibrations may indicate a change in road surfaces. In another example, when two or more vibration sensors 1142 are used, the differences between the vibrations may be used to determine friction or slippage of the road surface (e.g., when the difference in vibration is between a power-driven axle and a freely rotating axle).

The vehicle 1100 may include an ADAS system 1138. The ADAS system 1138 may include a SoC, in some examples. The ADAS system 1138 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1160, LIDAR sensor(s) 1164, and/or a camera(s). The ACC systems may include longitudinal ACC and/or lateral ACC. Longitudinal ACC monitors and controls the distance to the vehicle immediately ahead of the vehicle 1100 and automatically adjust the vehicle speed to maintain a safe distance from vehicles ahead. Lateral ACC performs distance keeping, and advises the vehicle 1100 to change lanes when necessary. Lateral ACC is related to other ADAS applications such as LCA and CWS.

CACC uses information from other vehicles that may be received via the network interface 1124 and/or the wireless antenna(s) 1126 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1100), while the I2V communication concept provides information about traffic further ahead. CACC systems may include either or both I2V and V2V information sources. Given the information of the vehicles ahead of the vehicle 1100, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1160, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1160, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1100 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1100 if the vehicle 1100 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1160, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1100 is backing up. Some RCTW systems include AEB to ensure that the vehicle brakes are applied to avoid a crash. RCTW systems may use one or more rear-facing RADAR sensor(s) 1160, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1100, the vehicle 1100 itself must, in the case of conflicting results, decide whether to heed the result from a primary computer or a secondary computer (e.g., a first controller 1136 or a second controller 1136). For example, in some embodiments, the ADAS system 1138 may be a backup and/or secondary computer for providing perception information to a backup computer rationality module. The backup computer rationality monitor may run a redundant diverse software on hardware components to detect faults in perception and dynamic driving tasks. Outputs from the ADAS system 1138 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1104.

In other examples, ADAS system 1138 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1138 may be fed into the primary computer's perception block and/or the primary computer's dynamic driving task block. For example, if the ADAS system 1138 indicates a forward crash warning due to an object immediately ahead, the perception block may use this information when identifying objects. In other examples, the secondary computer may have its own neural network which is trained and thus reduces the risk of false positives, as described herein.

The vehicle 1100 may further include the infotainment SoC 1130 (e.g., an in-vehicle infotainment system (IVI)). Although illustrated and described as a SoC, the infotainment system may not be a SoC, and may include two or more discrete components. The infotainment SoC 1130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1100. For example, the infotainment SoC 1130 may radios, disk players, navigation systems, video players, USB and Bluetooth connectivity, carputers, in-car entertainment, Wi-Fi, steering wheel audio controls, hands free voice control, a heads-up display (HUD), an HMI display 1134, a telematics device, a control panel (e.g., for controlling and/or interacting with various components, features, and/or systems), and/or other components. The infotainment SoC 1130 may further be used to provide information (e.g., visual and/or audible) to a user(s) of the vehicle, such as information from the ADAS system 1138, autonomous driving information such as planned vehicle maneuvers, trajectories, surrounding environment information (e.g., intersection information, vehicle information, road information, etc.), and/or other information.

The infotainment SoC 1130 may include GPU functionality. The infotainment SoC 1130 may communicate over the bus 1102 (e.g., CAN bus, Ethernet, etc.) with other devices, systems, and/or components of the vehicle 1100. In some examples, the infotainment SoC 1130 may be coupled to a supervisory MCU such that the GPU of the infotainment system may perform some self-driving functions in the event that the primary controller(s) 1136 (e.g., the primary and/or backup computers of the vehicle 1100) fail. In such an example, the infotainment SoC 1130 may put the vehicle 1100 into a chauffeur to safe stop mode, as described herein.

The vehicle 1100 may further include an instrument cluster 1132 (e.g., a digital dash, an electronic instrument cluster, a digital instrument panel, etc.). The instrument cluster 1132 may include a controller and/or supercomputer (e.g., a discrete controller or supercomputer). The instrument cluster 1132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1130 and the instrument cluster 1132. In other words, the instrument cluster 1132 may be included as part of the infotainment SoC 1130, or vice versa.

FIG. 11D is a system diagram for communication between cloud-based server(s) and the example autonomous vehicle 1100 of FIG. 11A, in accordance with some embodiments of the present disclosure. The system 1176 may include server(s) 1178, network(s) 1190, and vehicles, including the vehicle 1100. The server(s) 1178 may include a plurality of GPUs 1184(A)-1184(H) (collectively referred to herein as GPUs 1184), PCIe switches 1182(A)-1182(H) (collectively referred to herein as PCIe switches 1182), and/or CPUs 1180(A)-1180(B) (collectively referred to herein as CPUs 1180). The GPUs 1184, the CPUs 1180, and the PCIe switches may be interconnected with high-speed interconnects such as, for example and without limitation, NVLink interfaces 1188 developed by NVIDIA and/or PCIe connections 1186. In some examples, the GPUs 1184 are connected via NVLink and/or NVSwitch SoC and the GPUs 1184 and the PCIe switches 1182 are connected via PCIe interconnects. Although eight GPUs 1184, two CPUs 1180, and two PCIe switches are illustrated, this is not intended to be limiting. Depending on the embodiment, each of the server(s) 1178 may include any number of GPUs 1184, CPUs 1180, and/or PCIe switches. For example, the server(s) 1178 may each include eight, sixteen, thirty-two, and/or more GPUs 1184.

The server(s) 1178 may receive, over the network(s) 1190 and from the vehicles, image data representative of images showing unexpected or changed road conditions, such as recently commenced road-work. The server(s) 1178 may transmit, over the network(s) 1190 and to the vehicles, neural networks 1192, updated neural networks 1192, and/or map information 1194, including information regarding traffic and road conditions. The updates to the map information 1194 may include updates for the HD map 1122, such as information regarding construction sites, potholes, detours, flooding, and/or other obstructions. In some examples, the neural networks 1192, the updated neural networks 1192, and/or the map information 1194 may have resulted from new training and/or experiences represented in data received from any number of vehicles in the environment, and/or based on training performed at a datacenter (e.g., using the server(s) 1178 and/or other servers).

The server(s) 1178 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1190, and/or the machine learning models may be used by the server(s) 1178 to remotely monitor the vehicles.

In some examples, the server(s) 1178 may receive data from the vehicles and apply the data to up-to-date real-time neural networks for real-time intelligent inferencing. The server(s) 1178 may include deep-learning supercomputers and/or dedicated AI computers powered by GPU(s) 1184, such as a DGX and DGX Station machines developed by NVIDIA. However, in some examples, the server(s) 1178 may include deep learning infrastructure that use only CPU-powered datacenters.

The deep-learning infrastructure of the server(s) 1178 may be capable of fast, real-time inferencing, and may use that capability to evaluate and verify the health of the processors, software, and/or associated hardware in the vehicle 1100. For example, the deep-learning infrastructure may receive periodic updates from the vehicle 1100, such as a sequence of images and/or objects that the vehicle 1100 has located in that sequence of images (e.g., via computer vision and/or other machine learning object classification techniques). The deep-learning infrastructure may run its own neural network to identify the objects and compare them with the objects identified by the vehicle 1100 and, if the results do not match and the infrastructure concludes that the AI in the vehicle 1100 is malfunctioning, the server(s) 1178 may transmit a signal to the vehicle 1100 instructing a fail-safe computer of the vehicle 1100 to assume control, notify the passengers, and complete a safe parking maneuver.

For inferencing, the server(s) 1178 may include the GPU(s) 1184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1333, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1333 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1333. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, using at least partially simulated data, at least one first position of one or more actors based at least on a first state of an environment;
applying first data to a deep neural network (DNN) to generate, using the at least one first position of the one or more actors, one or more predictions of at least one second position of the one or more actors;
applying second data corresponding to the one or more predictions to at least one machine learning model (MLM) to generate, based at least partially on the one or more predictions, a predicted action corresponding to one or more actions for an ego-vehicle;
assigning one or more outputs to the prediction using a value function based at least on a second state of the environment; and
updating one or more parameters of the at least one MLM based at least on the one or more outputs.

2. The method of claim 1, wherein the at least one MLM decodes at least a portion of a latent space of the DNN to generate the predicted action corresponding to the one or more actions.

3. The method of claim 1, further comprising predicting one or more positions of the one or more actors using the DNN, wherein the determining the at least one first position of one or more actors includes adjusting at least one of the predicted one or more positions based on modeling behavior of an actor to generate the at least one first position.

4. The method of claim 1, the second data encodes one or more goals of the one or more actions for the ego-vehicle.

5. The method of claim 1, wherein the DNN comprises a DNN trained using imitation learning.

6. The method of claim 1, wherein the prediction of the one or more actions is made using an actor network of the at least one MLM and at least one of the one or more parameters are of a critic network corresponding to the at least one MLM.

7. The method of claim 1, wherein the one or more actions include one or more trajectories for the ego-vehicle.

8. The method of claim 1, wherein the at least one second position of the one or more actors corresponds to a trajectory of an actor and the method includes extending the trajectory using a mechanical motion algorithm to generate an extended trajectory, wherein the one or more outputs correspond to the extended trajectory.

9. The method of claim 1, wherein the one or more actors include the ego-vehicle and at least one other vehicle.

10. The method of claim 1, comprising:
determining, using the second state of the environment, a likelihood of a collision between the ego-vehicle and another object in the environment; and
computing the one or more outputs based at least on the likelihood of the collision.

11. A processor comprising one or more circuits to use a deep neural network (DNN) as a world model for a simulation and to apply reinforcement learning to train at least one MLM to generate a prediction of one or more actions for an ego-machine using the simulation.

12. The processor of claim 11, wherein a latent space of the DNN is decoded into a state of the world model for the simulation to apply reinforcement learning to train the at least one MLM using the simulation.

13. The processor of claim 11, wherein the DNN comprises a DNN trained using imitation learning.

14. The processor of claim 11, wherein the at least one MLM is trained to generate a prediction of a trajectory for a vehicle.

15. The processor of claim 11, wherein reinforcement learning is applied using a value function, and wherein one or more value function neural networks are trained to generate a prediction of one or more outputs of the value function.

16. A system comprising:
one or more processing units;
one or more memory units storing instructions that, when executed by the one or more processing units, cause the one or more processing units to execute operations comprising:
receiving sensor data generated by one or more sensors of an ego-vehicle within an environment;
based at least in part on the sensor data, determining at least one first position of one or more actors;
applying first data indicating the at least one first position to a deep neural network (DNN) to generate, using the at least one first position of the one or more actors, one or more predictions of at least one second position of the one or more actors;
applying second data corresponding to the one or more predictions to a neural network to generate one or more predictions of one or more outputs of a value function;
determining one or more driving policies corresponding to the one or more outputs; and
transmitting data causing the ego-vehicle to perform one or more actions based on the one or more driving policies.

17. The system of claim 16, wherein the value function includes a state value function and one or more states of the value functions correspond to one or more times and one or more positions of the at least one second position in the latent space.

18. The system of claim 16, wherein the second data encodes one or more goals for the one or more driving policies and the one or more outputs correspond to the one or more goals.

19. The system of claim 16, wherein the neural network decodes at least a portion of a latent space of the DNN to generate the one or more predictions of the one or more outputs.

20. The system of claim 16, wherein the system is comprised in at least one of:
a control system for an autonomous or semi-autonomous machine;
a perception system for an autonomous or semi-autonomous machine;
a system for performing simulation operations;
a system for performing deep learning operations;
a system implemented using an edge device;
a system implemented using a robot;
a system incorporating one or more virtual machines (VMs);
a system implemented at least partially in a data center; or
a system implemented at least partially using cloud computing resources.
